(19) United States
(12) Patent Application Publication
(10) Pub. No.: US 2026/0319251 A1
(43) Pub. Date: Oct. 15, 2026

(54) LIGHT PROJECTOR

(71) Applicant: Snap Inc., Santa Monica, CA (US)

(72) Inventors: Brennon Lloyd Pennell, Canterbury (GB); David Mark Woods, Wantage (GB)

(21) Appl. No.: 19/100,247

(22) PCT Filed: Jul. 26, 2023
(86) PCT No.: PCT/EP2023/070755

§ 371 Date: Jan. 31, 2025

(30) Foreign Application Priority Data
Aug. 9, 2022 (EP) 22189551.9

(51) Int. Cl. G02B 27/01; G02B 27/00; G02B 27/18; G02B 27/28

(52) U.S. Cl. CPC G02B 27/0172; G02B 27/0018; G02B 27/18; G02B 27/286; G02B 2027/012; G02B 2027/0143

(57) ABSTRACT

A projector for an augmented reality or mixed reality headset is disclosed, comprising: a display defining an optical axis configured to receive light to generate first supplied light an exit pupil configured to couple the first supplied light into a waveguide for an augmented reality or mixed reality headset, the exit pupil comprising a first region and a second region; a first optical arrangement configured to couple the first supplied light from the display towards the exit pupil; and a first light blocker. A first partial reflection, which is an undesirable reflection of the first supplied light, can be reflected back into the light projector. The light projector is configured to separate the supplied and reflected light spatially and prevent the reflected light from being coupled into the waveguide using the light blocker.

### FIELD OF INVENTION

The present invention relates to a light projector, in particular a light projector for augmented reality or virtual reality applications.

### BACKGROUND TO THE INVENTION

In an augmented reality headset, a transparent waveguide is provided in front of an eye or eyes. A light projector transmits light towards the waveguide. Light from the projector can be coupled into the waveguide by an input diffraction grating. Light then propagates within the waveguide by total internal reflection and an output diffraction grating couples light out of the waveguide and towards a viewer. In use, a viewer can see light from their external environment, transmitted through the transparent waveguide, as well as projected light from the projector. This can provide an augmented reality experience.

Some light projectors for augmented or virtual reality applications generate a main image that is intended to be displayed to the user, as well as a second image, or “ghost image”, which is not intended to be generated or seen by the user. In some light projectors, the second image can be coupled into the waveguide and shown to the user unintentionally, which can obscure and reduce the clarity of the main image. Additionally, in augmented reality applications bright ambient lighting from the external environment can negatively affect the user-perceived contrast between the main image and the environment.

An object of the present invention is to address these issues.

### SUMMARY OF INVENTION

According to a first aspect of the invention, there is provided a projector for an augmented reality or mixed reality headset, comprising: a display defining an optical axis, configured to provide first supplied light; an exit pupil configured to couple the first supplied light into a waveguide for an augmented reality or mixed reality headset, the exit pupil comprising a first region and a second region; a first optical arrangement configured to couple the first supplied light from the display towards the exit pupil; and a first light blocker; wherein the first region is positioned off-centre from the optical axis in a first direction to enable a first partial reflection, formed by a partial reflection of the first supplied light at the exit pupil, to be reflected towards the display and reflected by the display back towards the second region of the exit pupil, which is off-centre from the optical axis in a second direction so that the first and second regions are at least partially spatially separated from one another; wherein the first light blocker is positioned at the second region to at least partially prevent the first partial reflection from being coupled into the waveguide, while enabling the first supplied light to be coupled into the waveguide through the first region.

In this way, the undesirable first partial reflection, which appears to the user as a second image (often referred to as a ghost image) if coupled into the waveguide, can be separated spatially from the first supplied light, which appears to the user as a first image. The first partial reflection can then be prevented, at least partially, from being coupled into the waveguide by the first light blocker. This improves the experience for a user by mitigating ghost effects. Additionally, separating the first partial reflection from the first supplied light in this way can be implemented in known light projectors without changing the size or number of pixels of the display. This means the second image can be removed in a way that is generally compatible with existing light projectors.

The display can be a reflective display, such as a liquid crystal on silicon (LCOS) display or a digital micromirror device (DMD). Alternatively, the display can be an emissive display, such as a micro-LED array, micro light emitting diode (uLED) display or an organic light emitting diode (OLED) display. In other embodiments, the display could be a transmissive display, which operate using similar principles to reflective displays. In particular, a transmissive display using integrated colour filters may be used.

Strictly speaking, the term “image” refers to light of a particular focus coupled into a waveguide that would be perceived as an image by the user during use, whereas “supplied light” refers to light supplied by the display, yet to form an image in the waveguide. For the sake of simplicity and conciseness, the term “supplied light”, which forms a (desirable) image as viewed by the user during use, may be used interchangeably with the term “image” throughout. For example, it may be pedagogically useful to refer to supplied light as an image before it is coupled into the waveguide and provided to the user as an image. Similarly, for brevity “reflected light”, which can appear as an (undesirable) image to the user if allowed to be coupled into the waveguide, may also be referred to throughout as an image. Specifically, the first supplied light and the first partial reflection may be referred to as first and second images, respectively. Second supplied light generated by the display and a corresponding second partial reflection, as described further below, may similarly be referred to as a third and fourth image, respectively.

The first region and the second region are preferably provided on respective sides of the optical axis (i.e. on opposite sides). The first optical arrangement can comprise one or more optical components, such as lenses, mirrors, beam splitters, wave plates, polarisers, or other components suitable for coupling light from the display to the exit pupil. The first optical arrangement may be configured to operate as and may be described as projection optics.

Preferably, the display is configured to provide the first supplied light to the first optical arrangement off-centre with respect to the optical axis so that the first supplied light is coupled towards the first region of the exit pupil. The display may couple the first supplied light only towards the first region, or at least not towards the second region. In this way, the display avoids coupling light towards the light blocker at the second region where it would be absorbed. In some scenarios, this avoids about half of the light from the display from being absorbed by the light blocker. Thus, the projector is made more efficient.

The display preferably provides one or more light cones in the first supplied light. The one or more light cones can have a chief ray that is not parallel to the optical axis. In this way, the first supplied light can be directed towards the first region of the exit pupil. The first partial reflection of the first supplied light can therefore be directed back towards the display and then towards the second region of the exit pupil where it can be absorbed or otherwise diffusely scattered.

The display can be enabled to provide the light to the first optical arrangement off-centre in a number of ways, depending on the type of display. In one example, an emissive display can comprise a plurality of asymmetrical collimators or lenses, one for each pixel, each asymmetrical collimator or lens oriented in the same manner and configured to inhibit light from a corresponding pixel from propagating towards one side of the optical axis. In another example, a reflective or transmissive display can be illuminated asymmetrically to enable the generation of an image with a reduced cone angle.

The first supplied light may travel centred along a path that subtends a non-zero angle with respect to the optical axis, so that the first supplied light is coupled towards the first region.

Preferably, the projector comprises: a first light source configured to illuminate the display to generate the first supplied light; and a second optical arrangement configured to couple light from the first light source to the display; wherein the display is a reflective display and the first light source and/or the second optical arrangement are configured to provide asymmetrical illumination of the display with respect to the optical axis to enable the display to provide the first supplied light to the first optical arrangement off-centre with respect to the optical axis. In this way, the display can couple the first supplied light towards the first region to avoid its absorption by the first light blocker.

The first light source and the second optical arrangement can be arranged to provide asymmetrical illumination of the display in a number of ways. In one example, the first light source can be configured to illuminate one half of a component of the illumination optics, such as a micro lens array, wherein the half is positioned entirely to one side of the component and the optical axis. Alternatively, the illuminated half could overlap with the optical axis while being positioned preferentially towards one side of the component. In these cases, the first light source may be aligned parallel to but displaced from the optical axis. In another example, the first light source may illuminate the second optical arrangement symmetrically, and the second optical arrangement may be tilted or otherwise arranged to provide light to the reflective display centered along a non-zero angle to the optical axis.

The second optical arrangement can comprise one or more optical components, such as lenses, mirrors, beam splitters, wave plates, polarisers, or other components suitable for coupling light from the reflective display to the exit pupil. The second optical arrangement may be configured as illumination optics suitable for coupling light from the first light source to the reflective display.

Reflective and transmissive displays typically require similar optical setups. Embodiments using a reflective display may therefore use a transmissive display alternatively.

Preferably, the first light source illuminates an entrance pupil. Any suitable optical component may be provided at the entrance pupil to condition the spatial and angular characteristics of the light from the first light source. The suitable optical component can be provided as part of the second optical arrangement to couple light from the first light source to the display. In one example, a micro lens array can be provided at the entrance pupil. In another example, homogenising light pipes may be provided at the entrance pupil to condition the light. The entrance pupil and the suitable optical component may be centrally aligned with one another, and the first light source may illuminate the entrance pupil preferentially on one side. This may allow the optical component provided at the entrance pupil to couple light from the first light source towards the display at a reduced cone angle, compared to a full illumination of the entrance pupil. The second light source may be arranged similarly to illuminate the entrance pupil preferentially on an opposing side.

Preferably, the second optical arrangement comprises a micro lens array. A micro lens array can provide a compact means of coupling light to the reflective display. Alternatively, the second optical arrangement could comprise one or more light homogenising pipes in place of the micro lens array.

Preferably, the first light source is configured to illuminate the micro lens array preferentially on one side of the micro lens array. In this way, one portion of the micro lens array does not receive light from the first light source, causing the micro lens array to couple light from the first light source towards the reflective display at a reduced cone angle, i.e., a reduced angular size, compared to a full illumination of the micro lens array. This enables the reflective display to generate and couple the first supplied light towards the first optical arrangement off-centre with respect to the optical axis. The second light source may be arranged similarly on an opposite side of the micro lens array.

Preferably, the micro lens array is provided at an entrance pupil at which light enters the light projector from the first light source, and the micro lens array couples this light to remaining components of the second optical arrangement. In this way, the asymmetric illumination of the micro lens array can reduce the angular size of the light from the first light source at the display. The remaining components of the second optical arrangement can then be configured to couple the light towards the reflective display so that the full linear extent of the reflective display is illuminated.

Preferably, the projector comprises a waveguide for an augmented reality or mixed reality headset, configured to receive light from the exit pupil and couple the received light towards a user. In this way, the projector can provide augmented reality images to a user. A transmitted component of the first supplied light may be coupled into the waveguide, and a reflected component of the first supplied light may reflect back from the waveguide towards and through the exit pupil. In this way, the first partial reflection may arise due to a reflected component of the first supplied light at the waveguide. In other examples, the partial reflection could arise due to a reflection from a refractive optical component configured to couple light from the display to the waveguide. In one example, this refractive optical component could be provided at the exit pupil.

Preferably, the first light blocker is switchable between a first state configured to at least partially prevent the first partial reflection from being coupled into the waveguide and a second state configured to enable light to be coupled into the waveguide. In this way, the light projector can operate in different modes that may require light to be able to enter the second region. Alternatively, the light blocker could be a baffle configured to absorb light of wavelengths emitted by the first light source, provided permanently covering the second region. In other alternative embodiments, the first light blocker could be any other suitable light absorber that is not switchable.

In one further example, the light blocker may be embodied as the absence of an input coupling element in, on or for a waveguide, so that the light is “blocked” from entering the waveguide as a result of the light not being in-coupled. In this case, the light blocker may not physically absorb the partial reflection, but rather block the partial reflection from being coupled towards a user.

Preferably, the projector comprises a second light source configured to illuminate the display to generate second supplied light, wherein the second light source and/or the second optical arrangement are configured to provide asymmetrical illumination of the second optical arrangement with respect to the optical axis to enable the display to provide the second supplied light to the first optical arrangement at a position that is off-centre with respect to the optical axis so that the second supplied light is coupled towards the second region of the exit pupil. In this way, the light projector can utilise a second light source in a number of ways. In one example, the light projector has a backup light source in the event that the first light source fails. In another example, the light projector can use each light source independently to create more complex overall images using the first supplied light and the second supplied light. Providing two light sources also affords the light projector more flexibility in terms of thermal management of the heat produced by each light source.

The first and second light sources could each be configured as a full colour display. Alternatively, the first and second light sources could be configured as monochromatic light sources of different colours. For example, the first and/or second light sources may be configured to emit one or more of red, green, blue, cyan or violet light. The first and second light sources could be configured as any light source known in the art that is suitable for augmented reality or mixed reality applications.

In some examples, the projector can comprise two waveguides, each configured to couple one of the first supplied light and the second supplied light into different eyes of the user.

Preferably, the second region is positioned off-centre with respect to the optical axis to enable a second partial reflection, formed by a partial reflection of the second supplied light at the exit pupil, to be reflected towards the display and reflected by the display back towards the first region of the exit pupil. In this way, the undesirable second partial reflection (which can also form a ghost image in the waveguide) can be separated spatially from the second supplied light. This enables the second partial reflection to be prevented from being coupled into the waveguide without impeding the coupling of the second supplied light into the waveguide. The illumination from the first and second light sources is respectively asymmetric; however, the illumination from each light source is asymmetric in equal and opposite ways with respect to the optical axis. In other words, the illumination from the second light source is, figuratively, a “mirror image” of the illumination from the first light source. This symmetry of the (asymmetric) illumination from the first and second light sources about the optical axis enables each of the first and second supplied light and their respective partial reflections to align with the first and second regions, respectively.

Preferably, the light projector comprises a second light blocker positioned at the first region, wherein the second light blocker is switchable between a third state configured to at least partially prevent the second partial reflection from being coupled into the waveguide and a fourth state configured to enable light to be coupled into the waveguide. In this way, the light projector can switch between a number of different configurations or modes that allows the first and second light sources to be used independently or in various other ways while still preventing unwanted ghost images from being coupled into the waveguide.

Preferably, the first light source and the second light source are configured to operate simultaneously while the first light blocker is in the second state and the second light blocker is in the fourth state. In this way, the light projector can utilise both light sources to provide images of greater intensity to the user. This can improve the contrast of the images as perceived by the user in bright ambient lighting conditions in augmented reality applications. The display can be configured to provide two images, using the first and second supplied light, respectively, that are identical or very similar, so that a brighter overall image is coupled towards the user's eyes. In such a configuration, the projector can be said to be operating in a “bright mode”. Alternatively, if the display is a reflective display, the display can be configured to use sequential illumination from the first and second light sources to generate two images that are different.

Preferably, the projector is configured to switch between a first configuration in which the first light source is turned on, the second light source is turned off, the first light blocker is in the first state and the second light blocker is in the fourth state, and a second configuration in which the first light source is turned off, the second light source is turned on, the first light blocker is in the second state and the second light blocker is in the third state. In this way, the projector may operate in an “anti-ghosting” mode, in which two light sources are used in tandem while preventing either of the first or second partial reflections, i.e. the unwanted ghost images, from entering the waveguide. The projector can be switchable between the bright mode and the anti-ghosting mode. Alternating between configurations also illuminates a larger area of the exit pupil, compared to the operation of a single light source. This can produce a more uniform waveguide image and reduce pupil banding effects, whilst also eliminating or reducing the presence of ghost images.

The projector can be configured to switch rapidly between the first and second configurations. For example, the projector can be configured to provide images to the user at a particular frame rate, and the projector can be configured to switch between the first and second configurations between frames. In this way, each light source can increase the proportion of time that each light source spends turned off. In turn, this can reduce the maximum operating temperature of the first and second light sources and spreads the thermal load between two components. The projector can be configured to alternate between the first configuration and the second configuration successively. For example, the light projector may turn on the first or second light source at a particular frame rate, and the light projector may successively switch between each configuration for each frame. This enables each light source to operate for half the time, compared to a single light source turned on for each frame. The frame rate may be selected at a minimum of about 24 frames per second so that the user can perceive smooth motion.

In other embodiments, the projector could alternate between the first and second configurations in irregular patterns. For example, one light source may be turned on more frequently or for longer periods than the other light source. This may be beneficial for keeping one light source as a backup light source.

Preferably, the first light blocker comprises a polariser configured to block light of a first polarisation angle, and a switchable waveplate configured to selectively transpose light coupled towards the polariser from a second polarisation angle, the second polarisation angle being perpendicular to the first polarisation angle. The second light blocker may be configured in the same way as the first light blocker. In this way, the first light blocker and/or the second light blocker can be rapidly switchable by applying a time varying voltage to the switchable waveplate. Additionally, light projectors can typically comprise a polarising beam splitter, and this configuration of light blocker makes use of polarising beam splitters in existing designs.

Alternatively, the first and/or second light blockers can be configured in a number of alternative ways. For example, the light blockers could be configured as mechanical shutters configured to rapidly open or close to enable light to respectively reach or be prevented from reaching the waveguide via the first and second regions. In another example, the light blockers can be configured as transmissive liquid crystal panels capable of rapidly switching states so that the liquid crystals in the panels either absorb light or permit free passage of light through the panel.

Preferably, the first region and the second region are spatially separated along a longitudinal axis, and the longitudinal axis is oriented to minimise the distance between the display and the exit pupil. In this way, the first and second regions can be provided using existing designs for a projector without increasing the distance between the reflective display and the exit pupil, which can otherwise make the light projector more complicated to design and optimise.

The exit pupil is preferably configured as an elliptical exit pupil, and the first and second regions are separated along the elongate axis of the elliptical exit pupil. In other embodiments, the exit pupil can be circular, or more than one exit pupil could be provided wherein each exit pupil overlies one of the first and second regions.

Preferably, the reflective display is a liquid crystal on silicon, LCOS, display or a digital micromirror device, DMD. Other types of reflective display suitable for augmented or virtual reality applications could also be implemented.

In one example embodiment, the second optical arrangement comprises a polarising beam splitter, and the display is a reflective display comprising an LCOS panel. In this case, the first and/or second light blockers may preferably comprise a polariser and switchable waveplate. In another example embodiment, the second optical arrangement comprises a totally internally reflecting prism, and the display comprises a digital micromirror device.

The projector may also be described as a light projector.

According to a second aspect of the invention, there is provided a projector for an augmented reality or mixed reality headset, comprising: a display defining an optical axis, configured to provide first supplied light and second supplied light; an exit pupil configured to couple the first supplied light and the second supplied light into one or more waveguides for an augmented reality or mixed reality headset, the exit pupil comprising a first region and a second region; and a first optical arrangement configured to couple the first supplied light and the second supplied light from the display towards the exit pupil; wherein the display is configured to provide the first supplied light and the second supplied light respectively to the first optical arrangement off-centre with respect to the optical axis so that the first supplied light is coupled towards a first region of the exit pupil and the second supplied light is coupled towards a second region of the exit pupil; wherein the first region is positioned off-centre from the optical axis in a first direction and the second region is positioned off-centre from the optical axis in a second direction so that the first and second regions are at least partially spatially separated from one another.

In this way, the projector can operate flexibly in a number of ways using the display to generate first supplied light and second supplied light. In one example, the first supplied light and the second supplied light may be configured to provide two of the same or two different images to the user to produce different optical effects. The display can be operated to provide the first and second supplied light simultaneously, or the projector can alternate between configurations in which only one of the first and second supplied light is provided at one time. Preferably, the first region is positioned off-centre from the optical axis in a first direction to enable a first partial reflection, formed by a partial reflection of the first supplied light at the exit pupil, to be reflected towards the display and reflected by the display back towards the second region of the exit pupil; and the second region is positioned off-centre from the optical axis in a second direction to enable a second partial reflection, formed by a partial reflection of the second supplied light at the exit pupil, to be reflected towards the display and reflected by the display back towards the first region of the exit pupil; and the projector further comprises a first light blocker positioned at the second region, wherein the first light blocker is switchable between a first state configured to at least partially prevent the first partial reflection from being coupled into the one or more waveguides and a second state configured to enable light to be coupled into the one or more waveguides.

In this way, when the first light blocker is in the first state, the projector can prevent the first partial reflection from entering the waveguide in order to improve the clarity of a first image arising from the first supplied light. The first light blocker is switchable from the first to the second state. Providing a switchable light blocker makes the light projector more flexible. For example, this allows the second supplied light to be coupled into the waveguide when the first and second supplied light are generated simultaneously. Operating in this configuration enables the projector to provide brighter images to the user, which can improve the contrast of the images as perceived by the user. This is particularly useful in augmented reality or mixed reality applications, where the external environment can reduce the perceived contrast in bright ambient lighting conditions.

Preferably, the projector comprises a second light blocker positioned at the first region, wherein the second light blocker is switchable between a third state configured to at least partially prevent the second partial reflection from being coupled into the one or more waveguides and a fourth state configured to enable light to be coupled into the one or more waveguides. In this way, the projector can also block the second partial reflection from being coupled into the waveguide when the second supplied light is provided. Thus, when generating only one of the first or second supplied light, the projector can provide images of improved clarity.

Preferably, the projector further comprises: a first light source and a second light source configured to illuminate the display to generate the first supplied light and the second supplied light, respectively; and a second optical arrangement configured to couple light from the first light source and the second light source to the display; wherein the display is a reflective display and wherein the first light source, the second light source and/or the second optical arrangement are configured to provide asymmetrical illumination of the display with respect to the optical axis to enable the display to provide each of the first supplied light and the second supplied light to the first optical arrangement off-centre with respect to the optical axis. In this way, the display can couple the first supplied light towards the first region and the second supplied light towards the second region. This can avoid unnecessary absorption of light from the light sources by the first and second light blockers, making for a more efficient projector. As described with respect to the first aspect of the invention, the first light source and/or the second optical arrangement can be arranged in a number of ways to asymmetrically illuminate the display to enable the display to generate the first and second supplied light with a reduced cone angle towards the first and second regions, respectively.

Preferably, the projector is configured to switch between a first configuration in which the first light source is turned on, the second light source is turned off, the first light blocker is in the first state and the second light blocker is in the fourth state, and a second configuration in which the first light source is turned off, the second light source is turned on, the first light blocker is in the second state and the second light blocker is in the third state. In this way, the projector can provide images to the user using either of the light sources while preventing the first and second partial reflections, i.e. the unwanted ghost images, from being coupled into the waveguide. The projector can be configured to switch rapidly between the first and second configurations. For example, the light projector can be configured to provide images to the user at a particular frame rate, and the light projector can be configured to switch between the first and second configurations between frames. In this way, each light source can increase the proportion of time that each light source spends turned off. In turn, this can reduce the maximum operating temperature of the first and second light sources and spreads the thermal load between more components.

Preferably, the projector is configured to switch between the first configuration and the second configuration successively. More preferably, the light projector may turn on the first or second light source at a particular frame rate, and the light projector may successively switch between each configuration for each frame. This enables each light source to operate for half of the time, compared to a single light source turned on for each frame.

In other embodiments, the projector could alternate between the first and second configurations in irregular patterns. For example, one light source may be turned on more frequently or for longer periods than the other light source. This may be beneficial for keeping one light source as a backup light source.

Preferably, the first light source illuminates an entrance pupil. Any suitable optical component may be provided at the entrance pupil to condition the spatial and angular characteristics of the light from the first light source. The suitable optical component can be provided as part of the second optical arrangement to couple light from the first light source to the display. In one example, a micro lens array can be provided at the entrance pupil. In another example, homogenising light pipes may be provided at the entrance pupil to condition the light. The entrance pupil and the suitable optical component may be centrally aligned with one another, and the first light source may illuminate the entrance pupil preferentially on one side. This may allow the optical component provided at the entrance pupil to couple light from the first light source towards the display at a reduced cone angle, compared to a full illumination of the entrance pupil. The second light source may be arranged similarly to illuminate the entrance pupil preferentially on an opposing side.

In some embodiments, the display is a reflective display and the second optical arrangement comprises a micro lens array. More preferably, the first light source and the second light source are each configured to illuminate preferentially one of two opposing sides of the micro lens array. In this way, the micro lens array can couple light from each light source towards the reflective display at a reduced cone angle. This enables the reflective display to produce first supplied light and second supplied light, each of which are coupled towards the first optical arrangement off-centre with respect to the optical axis, so that the first supplied light and the second supplied light can be coupled towards the first and second regions, respectively. In other embodiments, the micro lens array could comprise one or more light homogenising pipes, or other optical components suitable for enabling the reflective display to couple the first and second supplied light to the exit pupil towards the first and second regions.

Preferably, the first light source and the second light source are configured to operate simultaneously. The display can be configured to generate the first supplied light and the second supplied light similarly or identically, so that two corresponding images appear to the user as a single brighter image. This can improve the contrast of the overall image perceived by the user.

In some embodiments, the light projector comprises a first waveguide and a second waveguide, and the exit pupil is configured to couple the first supplied light into the first waveguide and the second supplied light into the second waveguide. Preferably, the first waveguide is configured to couple the first supplied light into a first eye of a user and the second waveguide is configured to couple the second supplied light into the second eye of a user. In this way, the images provided to the user can be optimised for particular eyes, or optimised to generate particular effects in the overall image perceived by the user.

In other embodiments, the light projector comprises a waveguide configured to receive the first and second supplied light from the exit pupil and to couple the first and second supplied light towards a user.

According to a third aspect of the invention, there is provided a projector for an augmented reality or mixed reality display, comprising: an optical axis, a display configured to provide one or more light cones, an optical arrangement configured to couple the one or more light cones from the display towards an exit pupil; the exit pupil configured to couple the one or more light cones into a waveguide for an augmented reality or mixed reality display; and a first light blocker; wherein (a) each light cone has a chief ray that is not parallel to the optical axis and is configured to propagate the one or more light cones to yield a first region of the exit pupil; (b) the first region is positioned off-centre from the optical axis in a first direction to enable a second region, formed by a partial reflection of the light cones at the first region by the waveguide back towards the display and at least partially reflected by the display back towards the second region of the exit pupil that is off-centre from the optical axis in a second direction so that the first and second regions are at least partially spatially separated from one another; and (c) the first light blocker is positioned at the second region to at least partially prevent the light cones at the second region from being coupled into the waveguide, while enabling the light cones at the first region to be coupled into the waveguide through the first region.

### BRIEF DESCRIPTION OF THE DRAWINGS Embodiments of the invention are now described, by way of example, with reference to the drawings, in which:

FIG. 1 is schematic diagram of a subsection of a known light projector;

FIG. 2 is schematic diagram of a subsection of a known light projector;

FIG. 3 is schematic diagram of a subsection of a known light projector;

FIG. 4 is schematic diagram of a subsection of an embodiment of the invention;

FIG. 5 is schematic diagram of a subsection of an embodiment of the invention;

FIG. 6 is schematic diagram of a subsection of an embodiment of the invention;

FIG. 7 is schematic diagram of a subsection of an embodiment of the invention;

FIG. 8 is schematic diagram of an embodiment of the invention;

FIG. 9 is schematic diagram of an embodiment of the invention;

FIG. 10 is schematic diagram of an embodiment of the invention;

FIG. 11 is schematic diagram of an embodiment of the invention;

FIG. 12 is schematic diagram of an embodiment of the invention;

FIG. 13 is schematic diagram of a subsection of an embodiment of the invention;

FIG. 14 is schematic diagram of a subsection of an embodiment of the invention;

FIG. 15 is schematic diagram of an embodiment of a second aspect of the invention;

FIG. 16 is schematic diagram of an embodiment of the invention;

FIG. 17 is schematic diagram of an embodiment of the invention;

FIG. 18 is schematic diagram of an embodiment of the invention;

FIG. 19 is schematic diagram of an embodiment of the invention; and

FIG. 20 is schematic diagram of part of a display that can be used to implement an embodiment of the invention.

### DETAILED DESCRIPTION OF THE DRAWINGS

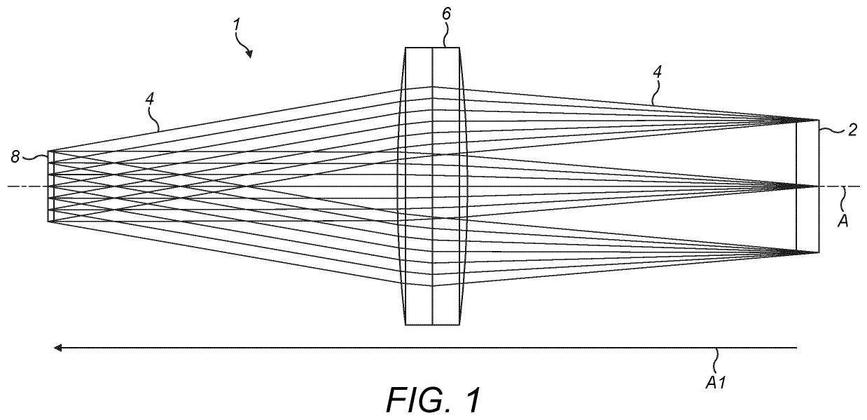

FIG. 1 shows a schematic diagram of a subsection of a known light projector. A light projector 1 is provided and comprises a display 2 configured to generate or provide light that forms a first image 4. FIG. 1 shows a number of exemplary light rays of the supplied light that together form the first image 4. The display 2 emits the supplied light forming the first image 4 in the direction of propagation shown by the arrow A1 towards an optical arrangement 6 configured to receive light from the display 2 and couple the received light towards an exit pupil 8. The optical arrangement 6 shapes the light forming the first image 4 in positional and angular space to an appropriate or desired size and directs the light towards the exit pupil 8. In particular, the optical arrangement 6 may shape the light in order to form the first image 4 at an infinite distance, making the first image 4 suitable for receipt by a waveguide for augmented reality. The exit pupil 8 contains all information required to output the first image 4 from a waveguide to a user's eye. Specifically, the exit pupil 8 can couple the first image 4 into the waveguide (not shown) suitable for augmented or virtual reality applications. The waveguide typically comprises an input diffractive optical element configured to in-couple light from the exit pupil 8 into the waveguide and an output element configured to out-couple the light representing first image 4 out of the waveguide towards the eye of a user. In an augmented reality or mixed reality headset, the waveguide is typically arranged so that the waveguide is positioned in front of the user's eye and outcouples images towards the eye.

Strictly speaking, the term “image” refers to light of a particular focus coupled into a waveguide that would be perceived as an image by the user in use, whereas “supplied light” refers to light supplied by the display, yet to form an image in the waveguide. For the sake of simplicity and conciseness, the term “supplied light”, which forms a (desirable) image as viewed by the user during use, may be used interchangeably with the term “image” throughout. For example, it may be pedagogically useful to refer to supplied light as an image before it is coupled into the waveguide and provided to the user as an image.

The display 2, the optical arrangement 6, and the exit pupil 8 are arranged centred on an optical axis A. The optical axis A is aligned with the geometric centre of the part of the reflective display 2 that generates the first image 4. The optical axis A also runs through the centre of each component of the known light projector 1 that interacts with the light. If the display 2 is a reflective or transmissive display, this can include a light source and any illumination optics that might be necessary to couple light from the light source to the reflective or transmissive display. In this way, the light projector 1 has rotational symmetry about the optical axis A. Thus, the light in the known light projector 1 is generally completely centred on the optical axis A. The rotational symmetry of the optical axis A can be illustrated by two reference rays, equidistant from and parallel to the optical axis A, which would have paths through the known light projector 1 mirrored with respect to the optical axis A.

In the schematic example shown in FIG. 1, the components of the known light projector 1 are shown to be arranged linearly and the light from the display 2 follows a generally linear path to the exit pupil 8. However, in practice the optical arrangement 6 could comprise one or more optical components that turn the light by 90 degrees, for example. In this case, the optical axis A would also turn by 90 degrees so that the optical axis A is aligned with the centre of each component that interacts with the light. In the known light projector 1, the display 2 is configured to emit the first image 4 centred on the optical axis A.

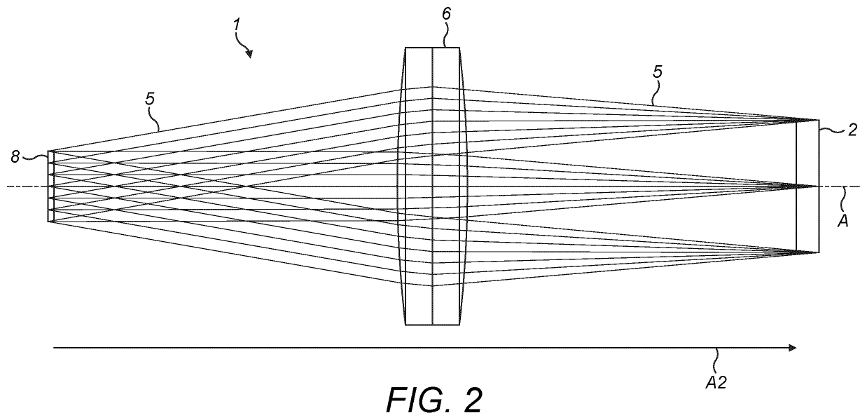

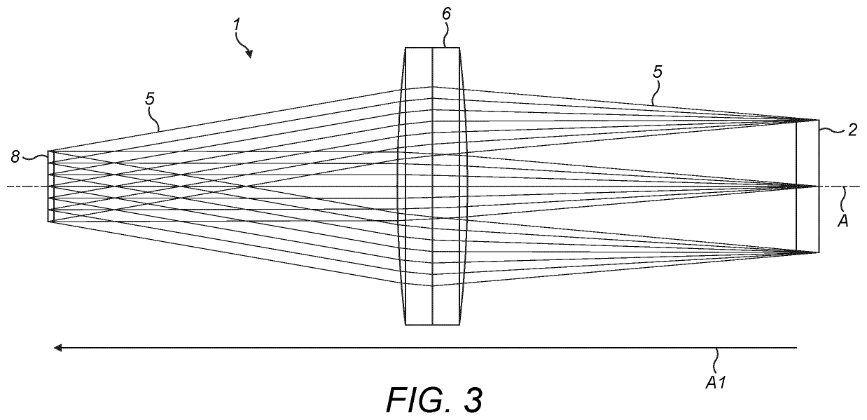

FIGS. 2 and 3 each show a schematic diagram of a subsection of the known light projector 1 to highlight one problem that has been found with such known light projectors.

As described above, the first image 4 is coupled towards the exit pupil 8 and coupled into the waveguide (not shown). The first image 4 can partially reflect from the input diffractive optical element of the waveguide and this reflection can propagate back through the light projector 1 as a partial reflection of the first image 4. This partial reflection will form a second image 5 in the waveguide.

For brevity “partial reflections” of images formed from supplied light, which can appear as an (undesirable) image to the user if allowed to be coupled into the waveguide, may also be referred to throughout as a “ghost image”.

The second image 5 propagates in the direction shown by the arrow A2 in FIG. 2. The second image 5 is at least substantially centred on the optical axis A. The reflected light that will form the second image 5 propagates through the optical arrangement 6, which couples the reflected light back towards the display 2. As a result of the reflective properties of the display 2, the second image 5 reflects from the display 2, which propagates once more in the direction of arrow A1 as shown in FIG. 3. The second image 5 is coupled from the display 2 to the exit pupil 8 via the optical arrangement 6. Subsequently, the second image 5, which is typically an inverted representation of the first image 4, is coupled into the waveguide as a ghost image, which couples the second image 5 towards a user.

The second image 5 is generally undesirable and can obscure the first image 4, which is the image intended to be shown to the user. The second image 5 is typically perceived by the user as a fainter copy of the first image 4 that is typically inverted relative the first image 4. Thus, the second image 5 is sometimes referred to as a “ghost image”. The second image 5 is continuously present in the overall image provided to the user in use, and it is challenging to mitigate or eliminate the presence of the second image 5. One concern of the present invention is to remove the presence of this ghost image from the overall image presented to the user.

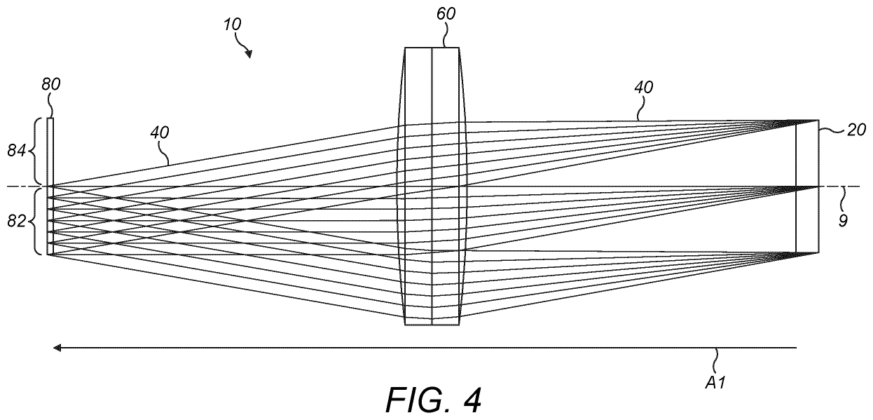

FIG. 4 shows a schematic diagram of subsection of a light projector according to an embodiment of the invention. A light projector 10 is provided and comprises a display 20 configured to generate a first image 40.

The display 20 may be a reflective display, transmissive display, or an emissive display. When the display 20 is a reflective or transmissive display, a light source is provided, which may illuminate the display with red, green and blue or red, green, cyan and violet light, for example, to yield a full colour image; alternately a single coloured light could be used when the display 20 is intended to produce monochrome images. When the display 20 is emissive, it comprises integral light sources, such as for example micro light emitting diodes (uLED's) or organic light emitting diodes (OLED's) which generate the first image 40 directly. The uLED's or OLED's may provide red, green and blue light to yield a full colour image, or may be monochrome.

FIG. 4 shows a number of exemplary light rays, which together form the first image 40. The display 20 provides the first image 40 in the direction of propagation shown by the arrow A1 towards an optical arrangement 60 configured to receive light from the display 20 and couple the received light towards an exit pupil 80. The first image 40 is provided in a plurality of cones of light, each cone having a chief ray that is not parallel to the optical axis 9. The optical arrangement 60 shapes the first image 40 in positional and angular space to an appropriate or desired size. The optical arrangement 60 shapes the light so that the first image 40 is formed at an infinite distance, which is a focal length suitable for receipt of the first image 40 by an augmented reality waveguide. The exit pupil 80 receives the first image 40 and allows the first image 40 to be coupled into a waveguide (not shown) suitable for augmented or virtual reality applications. The waveguide typically comprises an input diffractive optical element configured to in-couple light from the exit pupil 80 into the waveguide and an output diffractive element configured to out-couple light from the waveguide towards a user's eye. The waveguide can also be configured to expand the first image 40 using an intermediate grating or the output grating. By “expansion of the image”, it is meant that the exit pupil, which contains the entire first image 40, is replicated across the region of the output diffractive element, also sometimes referred to as the “eyebox”, through which a user's eye looks when moving through a range of angles, such as up, down, left and right. The larger the eyebox, the greater the likelihood a user will perceive first image 40 at any viewing angle.

The display 20, the optical arrangement 60, and the exit pupil 80 are arranged centred on an optical axis 9. The display 20 and the exit pupil 80 are arranged perpendicularly to the optical axis 9. Components of the optical arrangement 60 may also be arranged normal to the optical axis 9. The optical axis 9 is aligned with the geometric centre of the part of the display 20 that generates the first image 40 and is perpendicular to the surface of the display 20. Thus, the display 20 defines the optical axis 9. The optical axis 9 runs through the centre of each of the components of the light projector 10 shown in FIG. 4. In this way, the optical axis 9 defines a line of rotational symmetry, so that two rays emitted from the display 20 parallel to and equally distant from the optical axis 9 would follow similar but inverted paths through the components of the light projector 10 shown in FIG. 4. These reference rays would end up at the exit pupil 80.

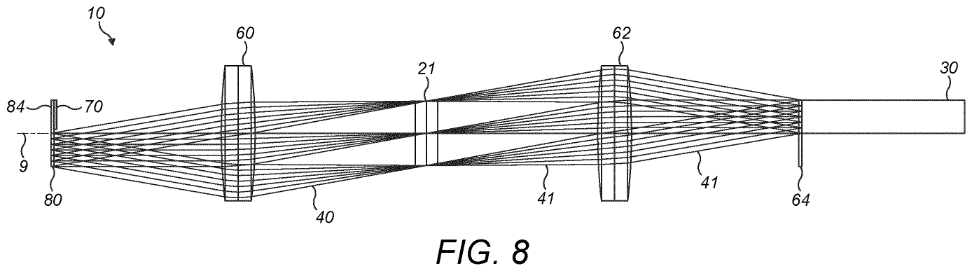

It should be understood that, unlike the optical axis A of the known light projector 1, the optical axis 9 may not be aligned centrally with all components of the light projector 10, in particular if a light source is used with a reflective display as described below with reference to FIG. 8.

In the schematic example shown in FIG. 4, for the purposes of illustration the components of the light projector 10 are arranged side by side, and the light from the display 20 appears to follow a generally straight path to the exit pupil 80. However, in practice the optical arrangement 60 may typically comprise one or more optical components that turn the light, for example by 90 degrees. In this case, the optical axis 9 would also turn by 90 degrees so that the optical axis 9 is aligned with the centre of each component that interacts with the light. Some components of the light projector, such as a beam splitter in a birdbath configuration, may create temporary branching paths of light before recombining the light into a single beam. Such components may be centred on the optical axis 9, and the optical axis 9 may turn in the manner described above only if the component is configured to produce a resultant change in direction in the light.

In the example embodiment of FIG. 4, when the display 20 is a reflective display it may be a liquid crystal on silicon (LCOS) display configured to generate an image from received light. The operation of the display 20 is described in more detail below. In other embodiments, the display 20 could be a digital micromirror device (DMD) display or any other kind of reflective display. If the display 20 is an emissive display it may be formed using microLED or OLED arrays, which may comprise red, green and blue or red, green, cyan and violet light sources, or which may be monochrome.

The optical arrangement 60 shown in FIG. 4 comprises a single focusing lens for the purposes of illustration. In practice, the optical arrangement 60 could comprise any number of a variety of optical components, such as lenses, mirrors, beam splitters, wave plates, polarisers, or other components suitable for coupling light from the display 20 to the exit pupil 80. The optical arrangement 60 could comprise components in a barrel or birdbath configuration, or some other configuration.

The exit pupil 80 is configured as an elongate aperture in a housing of the light projector 10. Alternatively, the exit pupil 80 could comprise two or more separate apertures, or a single aperture that is not elongate. In other embodiments, the exit pupil 80 could comprise an optical component, such as transparent glass, configured to couple the first image 40 into the waveguide.

The waveguide is positioned with respect to the exit pupil 80 so that the first image 40 is incident on an input grating of the waveguide. In other embodiments, intervening optical components could couple the first image 40 from the exit pupil 80 to the input grating. The input grating is configured to couple the first image 40 into the waveguide, which propagates through the waveguide by total internal reflection towards an output grating. The output grating then couples the first image 40 towards a user's eye. In augmented reality applications, the waveguide is usually transparent so that the external environment can be viewed through the waveguide. The first image 40 can be provided to the eye so that the first image 40 is viewed as an overlay on the surrounding environment.

Unlike the display 2 of the known light projector 1, the display 20 is configured to transmit the first image 40 off-centre with respect to the optical axis 9, as shown in FIG. 4. In particular, the first image 40 is coupled towards the optical arrangement 60 centred along a path that is at a non-zero angle to the optical axis 9. This enables the optical arrangement 60 to couple the first image 40 towards a first region 82 of the exit pupil 80 that is also off-centre with respect to the optical axis 9.

In particular, the first region 82 is shifted from the optical axis 9 so that the optical axis 9 is tangential to a peripheral edge of the first region 82. A second region 84 of the exit pupil 80 is also provided off-centre with respect to the optical axis 9 in an opposing direction to the first region 82. Similarly, the second region 84 is shifted from the optical axis 9 so that the optical axis 9 is tangential to a peripheral edge of the first region 84.

The exit pupil 80 is enlarged compared to the exit pupil 8, and in the embodiment of FIGS. 4 to 6 the exit pupil 80 is twice the width of the exit pupil 8. Specifically, each of the first and second regions 82, 84 have a width equal to that of the exit pupil 8, and the exit pupil 80 is elongate along the same axis along which the first and second regions 82, 84 are separated. As will be further described below in relation to further embodiments of the invention, this enables the exit pupil 80 to be wide enough to receive additional images from further light sources.

In other example embodiments, the first region 82 and the second region 84 may be partially overlapping. Alternatively or in addition, the first region 82 and the second region 84 may also be positioned so that the optical axis 9 is positioned within, rather than tangential to, the first region 82 and/or the second region 84. The first image 40 is coupled into the waveguide via the first region 82 of the exit pupil 80, so that the waveguide can provide the first image 40 to a user. In this example, the second region 84 does not receive any of the light that forms the first image 40. In an augmented reality headset, for example, the user experiences the first image 40 as an overlay on the environment.

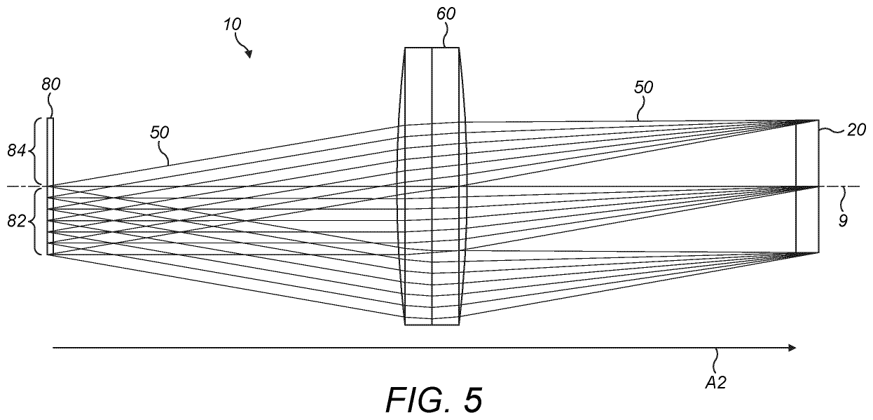

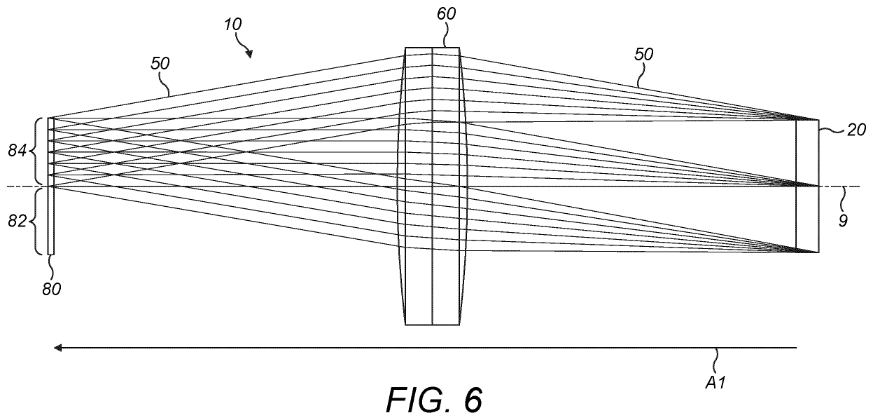

FIGS. 5 and 6 each show a schematic diagram of a subsection of the light projector 10. FIGS. 5 and 6 illustrate how the light projector 10 separates the first image 40 from a resulting ghost image.

The first image 40 may partially reflect from the input diffractive element of the waveguide, as described above in relation to the known light projector 1, so that a second image 50 propagates from the exit pupil 80 towards the display 20 in the direction A2 shown in FIG. 5. The second image 50 is a “ghost image”, or “partial reflection”, of the first image 40, as described previously, and is coupled from the first region 82 of the exit pupil 80 to the display 20 by the optical arrangement 60. For the purposes of clarity and illustration, the first image 40 is shown only in FIG. 4, however, in practice, the first image 40 and the second image 50 would be present in the light projector 10 simultaneously.

Advantageously, the second image 50 propagates from the first region 82, which is located to one side of the optical axis 9. This causes the second image 50 to propagate towards the optical arrangement 60 at a non-zero angle to, i.e., along a path non-parallel to, the optical axis 9 and reach the optical arrangement 60 off-centre with respect to the optical axis 9, as shown in FIG. 5. This causes the optical arrangement 60 to couple the second image 50 towards the display 20 so that the second image 50 is incident on the display 20 at a non-zero angle of incidence with respect to the surface of the display 20. The second image 50 then reflects from the display at an angle of reflection equal to and opposite the angle of incidence. The reflected second image 50 then propagates back towards the exit pupil 80 in the direction A1, as shown in FIG. 6.

The nature of the reflection of the second image 50 may vary depending on the type of display used as the display 20. For LCOS displays, the reflection is a specular reflection of light that has not undergone a change in polarisation by interaction with the liquid crystal. For DMD displays, the reflection would be a zeroth order diffraction. For a uLED or OLED display the reflection is a specular reflection from the surface of the display. However, in any case the resulting direction of propagation of the reflected light is the same as that of a specular reflection wherein the angles of incidence and reflection are equal and opposite. Returning to FIG. 6, the second image 50 is coupled towards the optical arrangement 60 off-centre with respect to the optical axis 9. The second image 50 is coupled towards the optical arrangement 60 centred along a path that is at an angle to the optical axis 9 equal to the angle of incidence at which the second image 50 encountered the reflective display 20. The optical arrangement 60 then couples the second image 50 towards the second region 84 of the exit pupil 80, so that the first region 82 does not receive any of the light that forms the second image 50. In this manner, the first image 40 and the second image 50 can be separated spatially, which allows the second image 50 to be prevented from being coupled into the waveguide while allowing the first image 40 to be coupled into the waveguide.

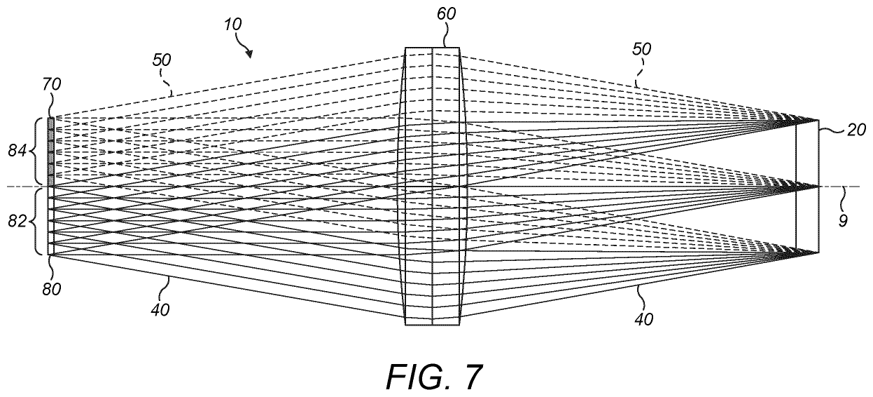

FIG. 7 shows a schematic diagram of a subsection of the light projector 10 of FIGS. 4 to 6 with the first image 40 and the second image 50 illustrated at the same time by exemplary light rays. As shown in FIG. 7, but omitted from FIGS. 4 to 6 for the purposes of illustration, the light projector 10 further comprises a light blocker 70 configured to prevent the second image 50 from being coupled into the waveguide at the exit pupil 80. The light blocker 70 is positioned at the second region 84 and absorbs the partially reflected light that forms the second image 50. Thus, the light blocker 70 prevents the second image 50 from entering the waveguide.

The light blocker 70 of FIGS. 4 to 7 comprises a piece of absorbing material that covers the second region 84 of the exit pupil. The material could be any material suitable for absorbing visible light. Other forms of light blockers could be used alternatively. For example, the light blocker 70 could be a switchable light blocker which can be switched on or off, as described below with respect to further embodiments of the invention.

One method by which the light projector 10 provides the first image 40 to the optical arrangement off-centre with respect to the optical axis 9 will now be described.

FIG. 8 shows a schematic diagram of an exemplary light projector 10 as implemented using a reflective display 21. The light projector 10 further comprises a light source 30 provided to one side of the optical axis 9, shown in FIG. 8 as above the optical axis 9. The light projector 10 comprises Illumination optics 62, i.e., an additional “optical arrangement”, which in this case includes a micro lens array 64. The illumination optics 62 are centred on the optical axis 9, and the micro lens array 64 is oriented perpendicular to the optical axis 9. The light source 30 is configured to emit light 41 towards one side of the micro lens array 64, which in turn couples the light 41 towards the remaining components of the illumination optics 62. The illumination optics 62 are configured to couple the light 41 received from the light source 30 to the reflective display 21. The illumination optics 62 also shape and interact with the light to give it the properties necessary for the reflective display 21 to supply light that forms the first image 40 using the light 41 from the light source 30.

The light source 30 comprises an array of LEDs and a collimating tube. However, in other embodiments the light source 30 could be or comprise any form of light source suitable for augmented or virtual reality applications. For example, the light source 30 could comprise one or more individual sources of monochrome light, each of which may be combined spatially into a single beam incident on the micro lens array 64.

The illumination optics 62 shown in FIG. 8 comprises a focusing lens for the purposes of illustration. In practice, the illumination optics 62 could comprise any number of a variety of optical components, such as lenses, mirrors, beam splitters, wave plates, polarisers, or other composite components suitable for coupling light 41 from the light source 30 to the reflective display 21. The illumination optics 62 could comprise components in a barrel or birdbath configuration, or in some other configuration. As described above in relation to the optical arrangement 60, each component of the illumination optics 62 is aligned centrally with the optical axis 9.

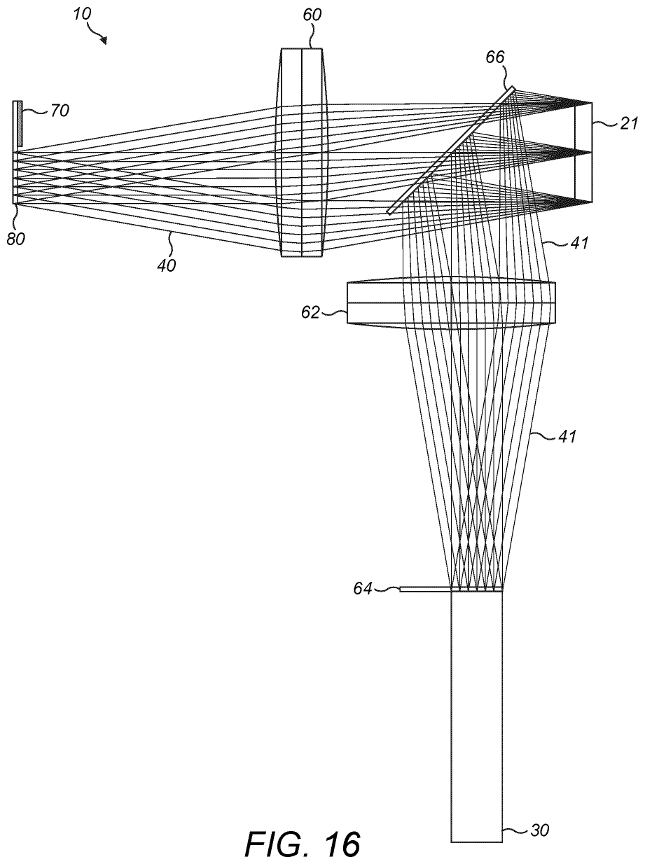

FIG. 8 shows the light projector 10 in a linear configuration for the purposes of illustration. However, the light projector 10 may be arranged in a more compact arrangement, for example using additional optical components in the illumination optics 62, as described above. One such arrangement is shown in FIG. 16. FIG. 16 shows a schematic illustration of the light projector 10, wherein the illumination optics 62 comprise an additional mirror 66 that couples light 41 from the light source 30 to the reflective display 21. The mirror 66 reflects the light by 90 degrees towards the reflective display 21 to enable a more compact arrangement. In one example, the mirror 66 may be positioned above or below the path from the reflective display 21 to the optical arrangement 60. It should be understood that FIGS. 8 and 16 are simplified embodiments and in practice the light projector may be significantly more compact.

The micro lens array 64 is provided at an entrance pupil, through which light 41 from the light source 30 passes to interact with remaining components of the light projector 10. In other embodiments, the micro lens array 64 could be an alternative optical component, such as a light homogenising pipe, for example, which may also be provided at the entrance pupil.

The light source 30 is provided to one side of the optical axis 9 in order to illuminate the micro lens array 64 preferentially on one side of the micro lens array 64. In the embodiment of FIGS. 4 to 8, the light source 30 illuminates approximately one half of the array; however, any off-centre illumination of the micro lens array 64 with respect to the optical axis 9 would suffice for the purposes of the invention. This partial and off-centre illumination of the micro lens array 64 causes the light 41 to be coupled towards the rest of the illumination optics 62 asymmetrically about the optical axis 9 and at a reduced angular size compared to an even and full illumination of the micro lens array 64. This, in turn, causes the light 41 to be coupled to the reflective display 21 by the remaining components of the illumination optics 62 with an asymmetric cone angle. This reduced cone angle can be seen in FIG. 8, which shows that the reflective display 21 is illuminated preferentially from above the optical axis 9, rather than from below the optical axis 9. Consequently, the first image 40 has a similarly reduced cone angle compared to the light 41 arriving at the reflective display 21. This reduced cone angle of the first image 40 enables the reflective display 21 to provide the first image 40 off-centre with respect to the optical axis 9, so that the first image 40 is coupled into the first region 82 of the exit pupil 9.

The illumination optics 62 shape and direct the light 41 so that it is incident on the full linear extent of the reflective display 21, as shown in FIG. 8. This allows the reflective display 21 to generate light forming a first image 40 with the same number of pixels as the first image 4, despite the reduced angular size of the light 41.

Coupling light from the light source 30 to the first region 82 as shown in FIGS. 4 to 8 thus enables the first image 40 and the second image 50 to be separated spatially without compromising the size or number of pixels of the reflective display 21 compared to the known light projector 1. Additionally, this method of separating the first image 40 from the second image 50 does not change the field of view of the first image 40 compared to the first image 4.

The first region 82 is displaced in an equal and opposite direction from the optical axis 9 compared to the light source 30. This is in part due to the unit magnification of the light from the entrance pupil, or in this embodiment the micro lens array 64, by the illumination optics 62 and the optical arrangement 60. However, other levels of magnification and other relative positions would be possible.

To generate the first image 40, the light 41 from the light source 30 illuminates the reflective display 21. The surface of the reflective display 21 comprises an array of pixels, which can be selectively switched between two or more states so that incoming light 41 from the light source 30 is selectively transmitted towards the optical arrangement 60 or blocked. In this way, the reflective display 21 spatially modulates the incoming light 41 to turn the illumination into a particular image. The reflective display 21 is configured as an LCOS display, however other reflective spatial light modulators could be used alternatively, such as a DMD display.

In the configuration shown in FIG. 8, the light projector 10 utilises a light source 30 that is aligned with but displaced from the optical axis 9 in order to illuminate one side of the micro lens array 64 preferentially. This provides asymmetrical illumination of the reflective display 21, enabling the reflective display 21 to supply light that is off-centre with respect to the optical axis 9. In other embodiments, the light source 30 can be configured or arranged in other ways.

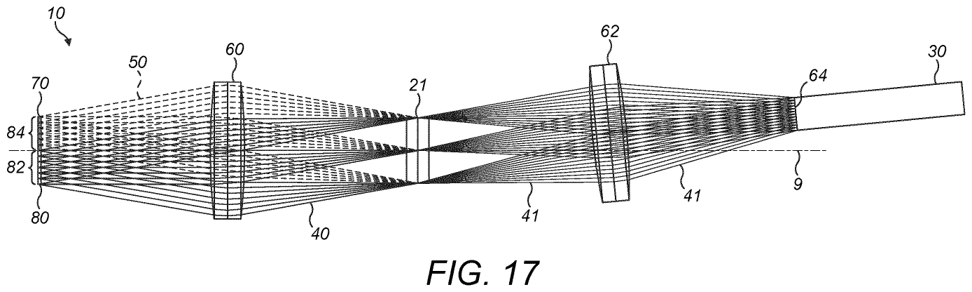

One such configuration is shown in FIG. 17, which shows a schematic diagram of the light projector 10 in an alternative configuration. In this arrangement, unlike the arrangement of FIG. 8, the light source 30 fully and evenly illuminates the micro lens array 64. However, the illumination optics 62, the micro lens array 64, and the light source 30 are tilted with respect to the optical axis 9 so that the light 41 from the light source 30 is coupled towards the reflective display 21 and centred on a path at a non-zero angle to the optical axis 9. This alternative arrangement is also capable of enabling the reflective display 21 to supply light to the optical arrangement off-centre with respect to the optical axis 9.

In other embodiments, the light source 30 and the illumination optics 62 may be arranged in a variety of ways. The light source 30 may be arranged with any suitable combination of tilt and displacement from the optical axis 9. Alternatively, the light source 30 and the micro lens array 64 could be fully aligned with and centred on the optical axis 9, and instead the illumination optics 62 may shape the light 41 so that it is incident on the reflective display 21 asymmetrically with respect to the optical axis 9.

Similar embodiments may involve additional light sources. In such cases, additional entrance pupils and micro lens arrays, or any other suitable components, for each of the additional light sources may be necessary to illuminate the illumination optics 62 from a different direction compared to the first light source 30, in order to couple corresponding images to different regions of the exit pupil 80.

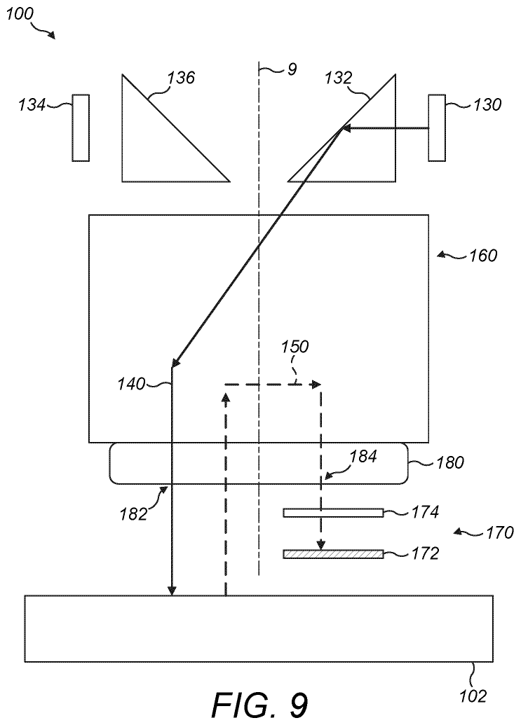

FIG. 9 shows a schematic diagram of a light projector according to another embodiment of the invention. A light projector 100 is provided and comprises a first light source 130, a first prism 132, a second light source 134 and a second prism 136. The first and second prisms 132, 136 are configured to couple light from the first and second light sources 130, 134, respectively, into an imaging system 160. The imaging system 160 comprises the illumination optics 62, including the micro lens array 64, the reflective display 21, and the optical arrangement 60 as described in relation to FIG. 8. The components of the imaging system 160 operate in the same way as described with respect to the light projector 10. The components of the imaging system 160 are provided in a compact arrangement suitable for use within an augmented or virtual reality headset, and are also centred on an optical axis 9 in the same manner as described previously. The light projector 100 also comprises an exit pupil 180, which has a first region 182 and a second region 184, which are provided off-centre from the optical axis 9 on opposing sides of the optical axis 9. As described above with respect to the light projector 10, the first and second regions 182, 184 are each provided to one side of the optical axis 9, so that the optical axis 9 is tangential to each region. A first light blocker 170 is provided at the second region 184. A waveguide 102 is provided and is configured to receive light from the first region 182 and the second region 184 of the exit pupil 180.

The first light source 130 and the second light source 134 may each comprise an arrangement of LEDs, for example an array of LEDs or singular LEDs. The first light source 130 and the second light source 134 may also be provided with collection or collimating optics to collimate light from a corresponding arrangement of LEDs. The collection or collimating optics may also be referred to as a collimating tube.

In other embodiments, the first light source 130 and the second light source 134 can be any form of light source suitable for illuminating the reflective display 21 to generate an image. The first and second prisms 132, 136 may be included to give the light projector 100 a more compact arrangement. However, other optical components could be provided to couple light from the first and second light sources 130, 134 to the imaging system 160. In an alternative embodiment the reflective display 21 could be an emissive display such as a uLED or OLED display as described above, in which case separate light sources 130, 134 may not be required.

The first light blocker 170 differs from the light blocker 70 in that the first light blocker 170 is switchable from a first state to a second state. In the first state, the first light blocker 170 absorbs light received from the imaging system 160 to prevent light from being coupled towards the waveguide 102. In the second state, the first light blocker 170 enables light to be coupled towards the waveguide 102. The light blocker comprises a polariser 172, configured to absorb light of a first polarisation angle while allowing light of a perpendicular polarisation angle to pass through the polariser 172 uninhibited. The polariser 172 may be any kind of polarising filter known in the art. A waveplate 174 is provided on the polariser 172 between the polariser 172 and the optical arrangement 60. For clarity, the first light blocker 170 is shown in FIG. 9 between the exit pupil 180 and the waveguide 102 with its component parts separated. In practice, the first light blocker 170 is provided at the second region 184 and the waveplate 174 is provided on the polariser 172. In other embodiments, the first light blocker 170 could be positioned in any appropriate position between the optical arrangement 60 and the waveguide 102.

The waveplate 174 is configured as a half-wave plate that rotates the polarisation angle of light passing through the waveplate 174 by 90 degrees. Additionally, the waveplate 174 is switchable, i.e. can be turned on or off. In one example, this can be achieved by applying different voltages to the waveplate 174. While turned off, the first light blocker 170 is in the first state and the waveplate 174 may be completely transparent or non-interacting with incoming light. While the waveplate 174 is turned on, the first light blocker 170 is in the second state, and the polarisation angle of light passing through the waveplate 174 is turned by 90 degrees.

Linear polarisation films such as the polariser 172 absorb half of the intensity of incident unpolarised light. Therefore, to ensure the polariser 172 can block the full intensity of incoming light, one of the optical arrangement 60 or the illumination optics 62 comprises an optical device that preferentially transmits light of a given polarisation, such as a polarising beam splitter (not shown), configured to convert unpolarised light from the first and second light sources 130, 134 to linearly polarised light of a particular orientation. In particular, the polarising beam splitter converts the light to an orientation parallel to the particular light-blocking orientation of the polariser 172. Thus, light from the first and second light sources 130, 134 are blocked by the polariser 172 by default, i.e. unless the waveplate 174 is turned on. The polarising beam splitter may be provided in a birdbath configuration comprising quarter wave plates, configured to convert an incident unpolarised beam to a polarised beam, as known in the art. In other embodiments, other polarising optical components may be provided alternatively or in addition to the polarising beam splitter.

The waveplate 174 can be turned on by applying a voltage to the waveplate 174 to switch the first light blocker 170 from the first state to the second state. Light reaching the waveplate 174 then has its polarisation angle turned by 90 degrees, enabling the light to pass through the polariser 172 uninhibited. The waveplate 174 may be rapidly switchable, so that the first light blocker 170 can be switched rapidly between the first state and the second state.

In other example embodiments, the switchable first light blocker 170 may be configured as a transmissive liquid crystal (LC) panel configured to change an orientation of the liquid crystals therein in response to a change in voltage. In this manner, the LC panel can selectively absorb or not absorb incoming light of a particular polarisation angle. In another example, the first light blocker 170 could be a mechanical shutter, configured to switch between open and closed states.

Next, operation of the light projector 100 will be described in greater detail.

The first light source 130 emits light towards a prism 132, as shown in FIG. 9. The prism 132 directs the light from the first light source 130 to one side of the micro lens array 64, which is provided in the imaging system 160. Thus, light is provided to the micro lens array 64 asymmetrically and off-centre with respect to the optical axis 9. As described previously, this light propagates through the imaging system 160, so that the light from the first light source 130 is received by the reflective display 21 at a reduced angular size. The reflective display 21 uses the received light to generate a first image 140 that is off-centre with respect to the optical axis 9. The first image 140 is coupled towards the first region 182 of the exit pupil 180 and towards the waveguide 102. The first light blocker 170 is positioned at the second region 184, and thus does not block the first image 140, which is coupled towards the first region 182.

As shown by a dashed line in FIG. 9, the first image 140 partially reflects from the waveguide 102, forming the second image 150. The second image 150 propagates towards the reflective display 21 until it is reflected by the reflective display 21 about the optical axis 9. The second image 150 then returns towards the exit pupil 180, moving generally away from the optical axis 9 towards the second region 184.

The second image 150 is linearly polarised due to the polarising beam splitter provided in the optical arrangement 60 or the illumination optics 62 of the imaging system 160. The polarising beam splitter linearly polarises the light so that it is parallel to the particular light-blocking orientation of the polariser 172. The second image 150 reaches the waveplate 174 of the first light blocker 170, which is turned off in the example shown in FIG. 9, meaning that the waveplate 174 does not interact with the second image 150. Thus, the polariser 172 absorbs the second image 150 to prevent it from entering the waveguide 102.

The first light blocker 170 could be configured in a variety of different configurations. For example, the first light blocker 170 could receive light in a first orientation, and the polariser 172 could be configured to block light of a second, perpendicular orientation. In this case, the waveplate 174 may be turned on to block the incoming light, rather than to allow it to pass through the polariser 172. The specific orientations will in general be dependent on the particular implementation of the imaging system 160.

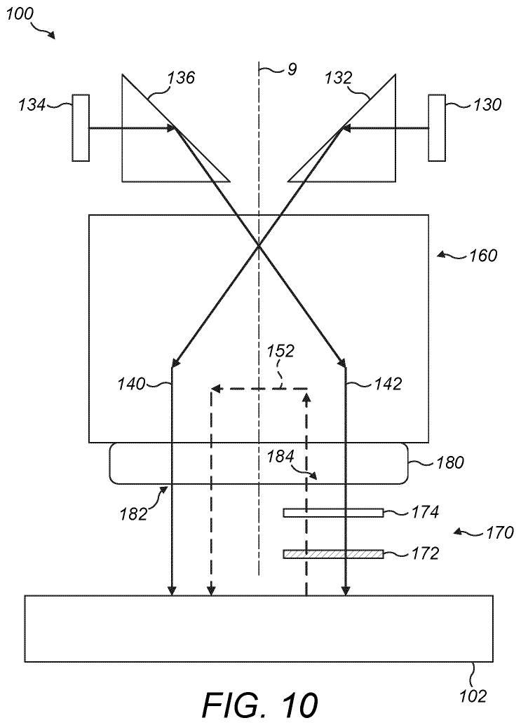

In augmented reality headsets, bright ambient lighting conditions can cause images from light projectors provided thereon to appear faint or of low contrast compared to the environment. In these situations, it may be desirable to have an additional light source that can be turned on to improve the contrast of the image, as perceived by a user. The light projector 100 can comprise a second light source 134, as shown in FIG. 10, which can be turned on to mitigate this issue.

FIG. 10 shows a schematic diagram of the light projector 100 operating in a “bright mode”, in which both the first light source 130 and the second light source 134 are turned on simultaneously. The light from the first light source 130 is formed into a first image 140 and coupled towards the first region 182, as described above with respect to FIG. 9. However, when the first light source 130 and the second light source 134 are operating simultaneously, the first light blocker 170 is configured to operate in the second state. Thus, the waveplate 174 is turned on so that light received by the waveplate 174 has its polarisation angle turned by 90 degrees, allowing the received light to pass through the polariser 172 uninhibited. This also allows the second image 150, not shown in FIG. 10 for clarity, to pass into the waveguide 102. However, the second image 150 (or any other partial reflection) tends to be significantly more faint than the first image 140, and so may be significantly less visible or completely invisible to the user in bright ambient lighting conditions.

The second light source 134 is configured to operate in the same way as the first light source 130, except that the position and orientation of the second light source 134 is flipped symmetrically about the optical axis 9. Thus, the path followed by light from the second light source 134 is a mirror image of the path taken by light from the first light source 130, but mirrored about the optical axis 9.

Specifically, the second light source 134 is directed by the second prism 136 to illuminate preferentially one side of the micro lens array 64, so that the first and second light sources 130, 134 preferentially illuminate opposing sides of the array. In the embodiment of FIGS. 9 and 10, the second light source 134 illuminates the remaining half of the micro lens array 64. In turn, this causes the micro lens array 64 to provide the light from the second light source 134 to the remaining components of the illumination optics 62 asymmetrically with respect to the optical axis 9 at a reduced cone angle. This reduced cone angle causes the reflective display 21 to provide a third image 142 that is also off-centre from the optical axis 9, but off-centre in an opposite direction compared to the first image 140. The optical arrangement 60 of the imaging system 160 is then configured to couple the third image 142 towards the second region 184 of the exit pupil 180. The third image 142 passes through the first light blocker 170 uninhibited, allowing the third image 142 to be coupled into the waveguide 102.

The exit pupil 180 is elongate in the same manner as the exit pupil 80, as described above with reference to FIG. 8, so that the exit pupil 80 has room to accommodate the first image 140 and the third image 142. The optical arrangement 60 of the imaging system 160 is configured symmetrically with respect to the optical axis 9, so that, like the first image 140, the third image 142 is provided to the first region 182 with a linear size equal to that of the first image 4.

The light projector 10 provides the first image 140 and the third image 142 with the same field of view, in particular with the same field of view as the first image 4 of the known light projector 1. In the bright mode, the light projector 100 can be programmed to generate the first image 140 the third image 142 as identical images, so that the first and third images 140, 142 can appear to the user as a single image with greater intensity. In augmented reality applications, this improves the perceived contrast with respect to the environment.

Alternatively, in other operating modes, the first and second light sources 130, 134 and/or the reflective (or, in other embodiments, emissive) display 21 can be used to generate different images.

A reflected component of the third image 142 at the waveguide 102 generates a fourth image 152, which is a ghost image of the third image 142. The approximate path of the fourth image 152 is shown in a dashed line in FIG. 10. The symmetry of the light projector 100 about the optical axis 9 causes the fourth image 152 to be directed by the imaging system 160 towards the first region 182, where it can enter the waveguide 102.

In particular, the second light source 134 also provides light asymmetrically to the illumination optics 62, with respect to the optical axis 9. However, this asymmetry is equal and opposite to the asymmetric way in which the first light source 130 illuminates the illumination optics 62. This mutual asymmetry about the optical axis 9 allows the first image 140 and fourth image 152 to be coupled towards the first region 182; while allowing the second image 150 and the third image 142 to be coupled towards the second region 184.

Like the second image 150, the fourth image 152 may be very faint or invisible in bright lighting conditions. This makes the presence of the second image 150 and the fourth image 152 less of a hindrance while the light projector 100 is operating in the bright mode.

However, providing two separate light sources in the manner described above can have advantages in other situations where a bright mode may not be necessary.

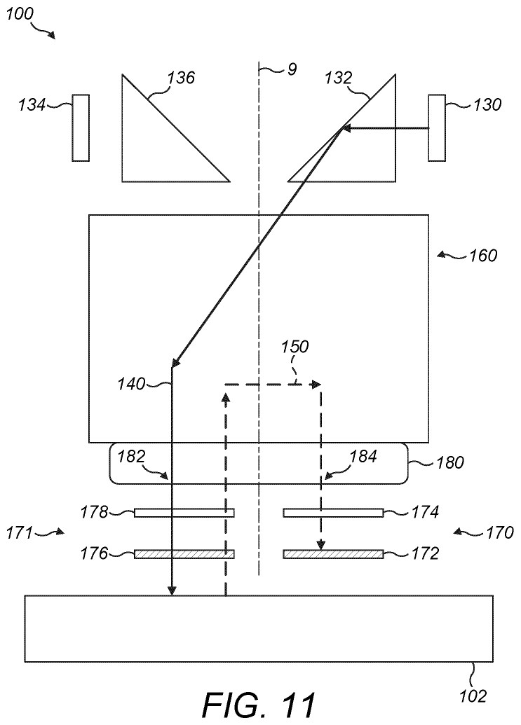

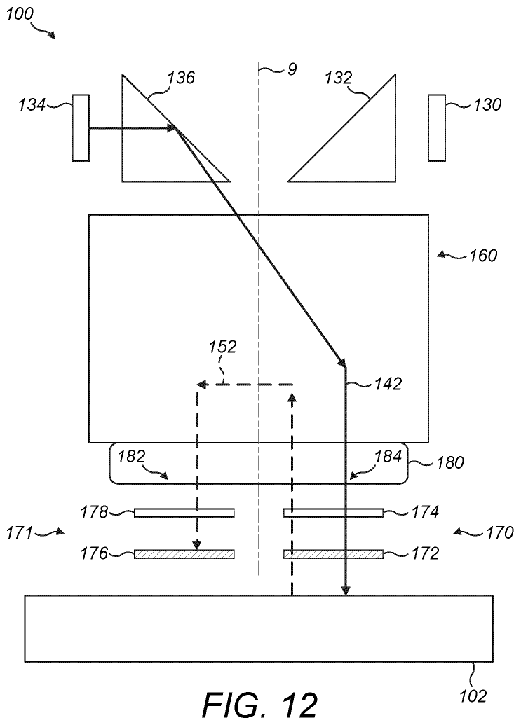

FIGS. 11 and 12 show an alternative embodiment of the light projector 100, comprising a second light blocker 171 provided at the first region 182. The second light blocker 171 comprises a polariser 176 and a waveplate 178, each of which are configured to operate in the same way as the polariser 172 and the waveplate 174 described previously. The second light blocker 171 is switchable between a first state, in which the waveplate 178 does not alter the polarisation angle of incident light, and a second state, in which the waveplate 178 turns the polarisation angle of incident light by 90 degrees, so that it can be absorbed by the polariser 176 as described with respect to the light blocker 170.

In the embodiment of FIGS. 11 and 12, the second light blocker 171 is provided as a separate light blocker to the first light blocker 170. In other embodiments, the first and second light blockers 170, 171 may be configured as a single polariser covering the exit pupil 180 with two independently switchable waveplates provided on the shared polariser.

The light projector 100 can be configured to switch between a first configuration, in which only the first light source 130 is turned on, and a second configuration, in which only the second light source 134 is turned on.

FIG. 11 shows the light projector 100 operating in the first configuration. In the first configuration, the second light blocker 171 is configured to operate in the second state. Therefore, the waveplate 178 turns the polarisation angle of light forming the first image 140 by 90 degrees, so that the polariser 172 does not stop the first image 140 from entering the waveguide 102. Consequently, the second image 150 is generated and passes through the second light blocker 171 to be directed towards the second region 184 by the imaging system 160. In the first configuration, the first light blocker 170 is configured to operate in the first state in order to prevent the second image 150 from entering the waveguide 102.

FIG. 12 shows the light projector 100 operating in the second configuration. In the second configuration, the first light blocker 170 is configured to operate in the second state. Therefore, the waveplate 174 turns the polarisation angle of light forming the third image 142 by 90 degrees, so that the polariser 176 does not stop the third image 142 from entering the waveguide 102. Consequently, the fourth image 152 is generated and passes through the first flight blocker 170 to be directed towards the first region 182 by the imaging system 160. In the second configuration, the second light blocker 171 is configured to operate in the first state in order to prevent the fourth image 152 from entering the waveguide 102.

Enabling the light projector 100 to operate in both of the first configuration and the second configuration provides a number of different benefits for the light projector 100. For example, this setup can provide functional redundancy, so that the light projector 100 can still operate to provide images to the user even if one of the first light source 130 or the second light source 134 fails. The embodiment of FIGS. 11 and 12 enables this redundancy to be achieved while continuing to prevent ghost images from being shown to the user. Additionally, the light projector 100 is able to produce the first image 140 and the third image 142 with the same field of view as the first image 4. This further improves the redundancy of the first light source 130 and the second light source 134 because each of the first and second light sources 130, 134 can provide the full field of view to the user.

The light projector 100 can be configured to switch rapidly between these first and second configurations in a number of possible patterns. In one example, the light projector 100 can alternate successively and between the first and second configurations periodically at a rate equal to a frame rate of the projector to provide an image to the user. This allows the first light source 130 to provide the image on one frame and the second light source 134 to provide the image on the next frame, in a repeating pattern. Operating in this way enables each of the first and second light sources 130, 134 to be turned on for half the time that a single light source would be turned on to provide images at the same frame rate. This can improve the thermal management of the first and second light sources 130, 134, for example by reducing the maximum temperature at which the first and second light sources 130, 134 operate.

The light projector 100 could also be configured to operate in other regular or irregular patterns, wherein the alternation between first and second configurations does not necessarily happen between each frame. In other uses of the embodiment of FIGS. 11 and 12, the light projector 100 can use each light source to provide completely different images, rather than the same image.

The light projector 100 may also be configured to operate in a third configuration, in which the light projector 100 can operate in the bright mode. In the third configuration, both of the first light source 130 and the second light source 134 are turned on, and both of the first light blocker 170 and the second light blocker 171 are in the second state so that no light is prevented from being coupled into the waveguide 102. This allows the embodiment of FIGS. 11 and 12 to operate in the bright mode in the same manner as the embodiment of FIGS. 9 and 10. The light projector 100 of FIGS. 11 and 12 may be switchable from the bright mode, i.e. the third configuration, to an “anti-ghosting” mode, in which the light projector 100 switches between the first and second configurations as described above.

In a further example embodiment (not shown in the Figures), light projector 100 can comprise multiple waveguides. For example, a first waveguide can be configured to couple the first image into a first eye of the user. A second waveguide can be configured to couple the third image 142 into the other eye of the user. In this case, the second image 150 arises due to a reflection of the first image 140 from the first waveguide. Similarly, the fourth image 152 arises due to a reflection of the third image 142 from the second waveguide. Such an embodiment of the light projector 100 could operate, and be configured, in the same manner as any of the embodiments described above with respect to FIGS. 9 to 12.

The light projector 100 of any of FIGS. 9 to 14 can comprise an optical element provided in the path of the first image, configured to angularly shift the first image 140 with respect to the third image 142. The optical element is configured to angularly shift the first image 140 with respect to the third image 142 by an angle corresponding to the angular width of half a pixel of the reflective display 21. This can artificially increase the resolution of the overall image provided to the user. The optical element can be a refractive wedge of glass, or any other suitable material for refracting light. Any other component could also be implemented. In one example, the optical element could be provided as a layer on one of the first or second light blockers 170, 171, or as a separate component within the optical arrangement 60.

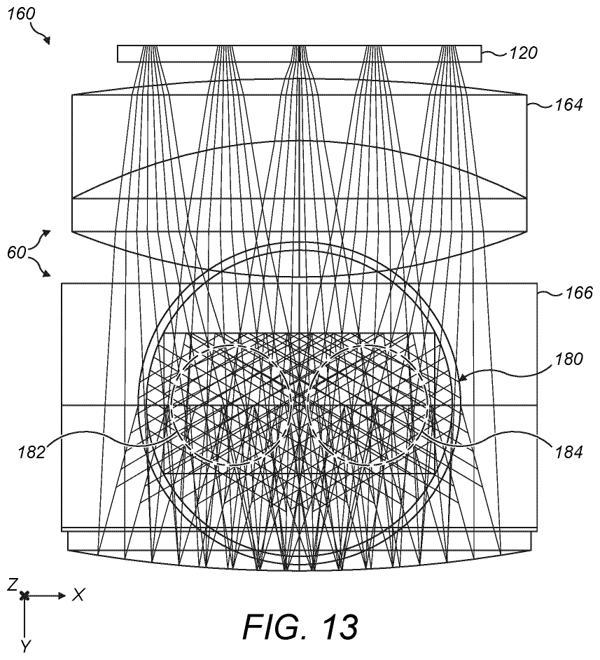

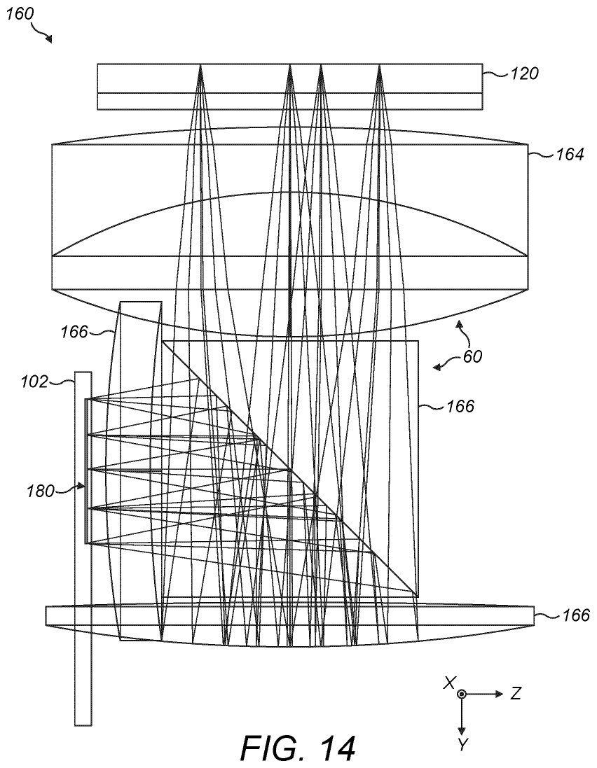

FIGS. 13 and 14 show schematic diagrams of an example imaging system 160 of FIGS. 9 to 12. FIG. 13 shows the imaging system 160 from a first point of view. FIG. 14 shows the imaging system 160 rotated, as shown by an axis in the corner of FIGS. 13 and 14. A number of example light rays are also shown to illustrate how light is coupled from the reflective display 120 to the first and second regions 182, 184 of the exit pupil 180. In this example imaging system 160, the optical arrangement 60 comprises a lens 164 configured to direct the light to a polarising beam splitter 166. For clarity, the first light blocker 170 and the second light blocker 171 are omitted from FIGS. 13 and 14.

As best seen from FIG. 14, the reflective display 120 couples light towards the polarising beam splitter 166 in a direction substantially parallel to the y-axis. As best seen in FIG. 13, the first region 182 and the second region 184 are separated along the x-axis and not along the y-axis. This is advantageous compared to a separation along the y-axis, which would require an increased distance between the exit pupil 180 and the reflective display 120 compared to known light projectors. In particular, separating the first and second regions 182, 184 in this way allows shorter focal lengths to be used, which allows for larger field of views for a given display size. Additionally, the design and optimisation of existing imaging systems can be used even with the enlarged exit pupil 180 of the present invention. This increases backwards compatibility and reduces the design cost and difficulty of designing the light projector 100. Selecting the axis of separation between the first and second regions 182, 184 in the manner of FIGS. 13 and 14 can also be applied to the light projector 10 of FIGS. 4 to 8. The imaging system 160 could have other configurations and the optical arrangement 60 could have other types of components. In such cases, the axis along which the first region 182 and the second region 184 are separated can be selected to avoid increasing the distance between the reflective display 120 and the exit pupil 180.

In the embodiments described with reference to FIGS. 9 to 14, the first and third images 140, 142 may be referred to as the first and second supplied light, as described previously. Similarly, the second and fourth images 150, 152 may be referred to as the first and second partial reflections.

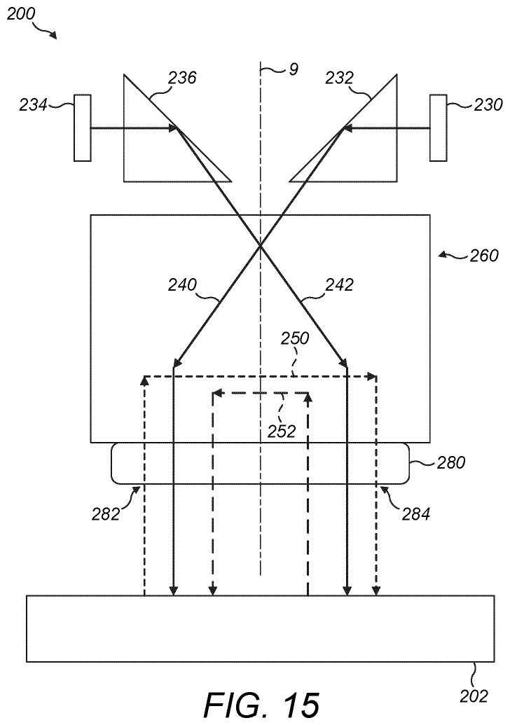

FIG. 15 shows a schematic diagram of a light projector 200 according to another embodiment of the invention.

A light projector 200 is provided and comprises a first light source 230, a first prism 232, a second light source 234 and a second prism 236. The first and second prisms 232, 236 are configured to couple light from the first and second light sources 230, 234, respectively, into an imaging system 260. The imaging system 260 comprises the illumination optics 62, including the micro lens array 64, the reflective display 21, and the optical arrangement 60 as described in relation to FIGS. 4 to 14. The components of the imaging system 260 operate in the same way as described with respect to the light projector 10 and the light projector 100. The components of the imaging system 260 are provided in a compact arrangement suitable for use within an augmented or virtual reality headset, and are also centred on an optical axis 9 in the same manner as described previously. The light projector 200 also comprises an exit pupil 280, which has a first region 282 and a second region 284, which are provided off-centre from the optical axis 9 on opposing sides of the optical axis 9. As described above with respect to the light projector 10, the first and second regions 282, 284 are each provided to one side of the optical axis 9, on opposing sides. A waveguide 202 is provided and is configured to receive light from the first region 282 and the second region 284 of the exit pupil 280. The light projector 200 is configured to generate a first image 240, resulting in a second image 250, and a third image 242, resulting in a fourth image 252, in the same manner as the light projector 100.

As described previously, the first and third images 240, 242 may be referred to as the first and second supplied light. Similarly, the second and fourth images 250, 252 may be referred to as the first and second partial reflections.

The light projector 200 is configured to operate in substantially the same way as the light projector 100. The light projector 200 differs from the light projector 100 only in that the light projector 200 does not comprise any light blockers. Thus, the light projector 200 can separate the first image 240 from the second image 250 and separate the third image 242 from the fourth image 252. However, the light projector 200 is not capable of preventing the second image 250 or the fourth image 252 from being coupled into the waveguide 202.

The light projector 200 can also operate in different modes, similar to the modes of the light projector 100. The light projector 200 can operate in the bright mode, as described with reference to FIG. 10, in which the first image 240 and the third image 242 are identical images and are displayed simultaneously to increase the contrast of the overall image seen by the user.

In another mode, the light projector 200 can also be switched between a first configuration in which only the first light source 230 is turned on and a second configuration in which only the second light source 234 is turned on. Similar to the light projector 100, the light projector 200 can switch rapidly between these configurations to improve the thermal management of the light projector 200, or to perform other functions.

In a further example embodiment (not shown in the Figures), light projector 200 can comprise multiple waveguides. For example, a first waveguide can be configured to couple the first image 240 into a first eye of the user. A second waveguide can be configured to couple the third image 242 into the other eye of the user. In this case, the second image 250 arises due to a reflection of the first image 240 from the first waveguide. Similarly, the fourth image 252 arises due to a reflection of the third image 242 from the second waveguide.

The above-described embodiments utilise a display capable of directing light towards a particular region of the exit pupil. Generally, this enables supplied light that forms a first image in the waveguide to avoid encountering a light blocker (or a light blocker in a light blocking state) so that the supplied light is not wasted. However, in a simpler embodiment, a partial reflection of the first image can still be prevented from entering the waveguide without utilising a display that supplies light to an optical arrangement off-centre with respect to the optical axis 9.

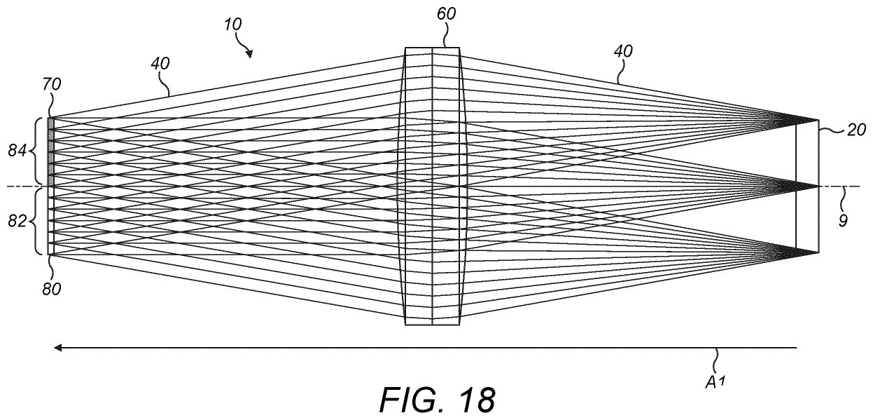

FIG. 18 shows a schematic diagram of such an embodiment of the light projector 10, in which the display 20 supplies light to the optical arrangement 60 centred on the optical axis 9 in the direction A1. The light forming the first image 40, referred to also as the first image 40 for conciseness, is provided to the optical arrangement 60 centred on the optical axis 9. The light is then coupled by the optical arrangement 60 from the display 20 towards the exit pupil 80. In this instance, unlike the configurations of FIGS. 4 to 16, the display 20 does not supply light with a reduced cone angle. Consequently, the first image 40 is coupled towards both the first region 82 and the second region 84. The light blocker 70 is provided at the second region 84, which absorbs half of the originally supplied light by the display 20.

The first image 40 can reflect from a waveguide or any other reflecting component provided after the exit pupil 80, resulting in a partial reflection that would form a second image 50 if coupled into the waveguide. For brevity, the partial reflection may be referred to as the second image 50.

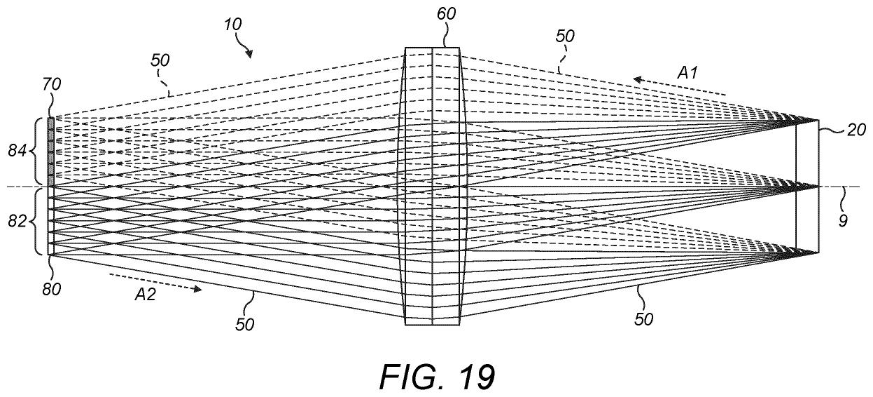

FIG. 19 shows the resulting return path of the second image 50, starting from the first region 82 and propagating in the direction A2, reflecting at the display 20, and ending at the light blocker 70. Due to the light blocker 70 covering the second region 84, only light from the first region 82, which is to one side of the exit pupil 80, is coupled back into the light projector 10. This causes the second image 50 to have a reduced cone angle relative to supplied light from the display 20 and causes the second image 50 to illuminate the optical arrangement 60 asymmetrically. The first region 82 is positioned to one side of the optical axis 9, causing the optical arrangement 60 to focus the second image 50 towards the display 20 at a non-zero angle to the optical axis 9.

The partial reflection 50 subsequently reflects once more at the display 20, and propagates back towards the exit pupil 80 in the direction shown by arrow A1. The non-zero angle of travel of the second image 50 relative to the optical axis 9 causes the optical arrangement 60 to couple the second image 50 towards the second region 84 of the exit pupil 80, where it encounters the light blocker 70 and becomes absorbed. In this way, ghost images can be prevented without utilising a display configured to provide images of a reduced angular size.

As mentioned previously, in this embodiment the light blocker 70 absorbs half of the originally supplied light by the display 20. This makes this configuration of FIGS. 18 and 19 less efficient than previously described embodiments because half of the supplied light is effectively wasted. However, this configuration can be implemented easily in existing projector designs by providing a light blocker over half of the exit pupil on one side of the optical axis 9. This approach of FIGS. 18 and 19 could be implemented using any kind of display.

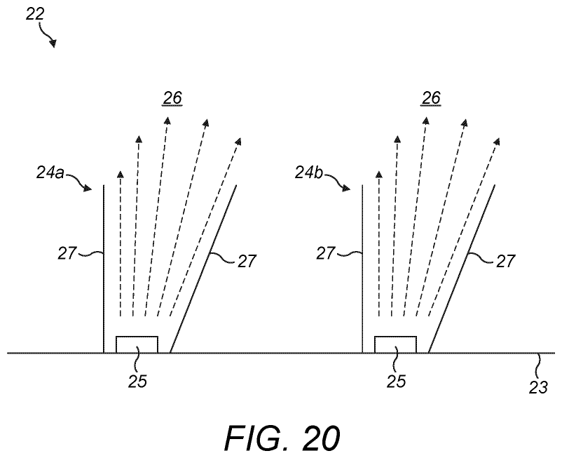

FIG. 20 shows a schematic diagram of part of an emissive display 22 that can be used in embodiments of the invention. In particular, FIG. 20 illustrates how light of a reduced cone angle can be generated using an emissive display to enable the emission of images that are provided off-centre with respect to the optical axis.

The emissive display 22 comprises a base 23 on which a plurality of pixels are provided, including an exemplary first pixel 24a and an exemplary second pixel 24b. Each pixel comprises one or more LEDs 25 configured to generate light 26 of one or more colours. The pixels can be turned on or off individually in order to generate an image that can be provided to an optical arrangement for coupling to an exit pupil. In practice, a large array of pixels may be provided on the emissive display 22. The pixels may also be spaced more closely together than depicted in FIG. 20.

Each pixel comprises a collimating tube 27 that is asymmetric so that emitted light 26 is coupled preferentially towards one side of the optical axis 9, which perpendicularly bisects the geometric centre of the emissive display 22. The first pixel 24a and the second pixel 24b are provided with collimating tubes 27 that are flared on their right sides only. The non-flared side of the collimating tubes 27 prevents emitted light from propagating towards the non-flared left side, reducing the cone angle of emitted light in that direction. In this way, emitted light 26 from the emissive display 22 can be provided with a reduced cone angle so that images can be provided off-centre from the optical axis 9. As described previously, this enables images to be coupled towards one of two opposing regions of an exit pupil that are offset from the optical axis 9.

In light projectors of the invention, such as the those described in relation to FIGS. 4 to 17, each pixel on the emissive display 22 has a collimating tube 27 that reduces the cone angle in the same direction, regardless of the position of the pixel on the emissive display 22. This allows the full extent of the emissive display 22 to be used to provide a single image that is coupled towards one region of the exit pupil.

In embodiments of the invention comprising multiple imaging channels, i.e. embodiments of the light projector 100 or light projector 200 described in relation to FIGS. 9 to 15, the invention can be implemented using separate emissive displays. For example, a first emissive display can be provided with collimating tubes 27 oriented to block light propagating towards a first side of the optical axis 9 and a second emissive display can be provided with collimating tubes 27 oriented oppositely to block light from propagating towards a second side of the optical axis 9 opposite to the first side. This allows each emissive display to provide off-centre images in opposing directions that can be coupled into different regions of an exit pupil.

Partial reflections arising from (desirable) images entering a waveguide may reach the emissive display 22 in the same manner as described previously. For emissive displays 22, these partial reflections can re-reflect or scatter from the surfaces of the LEDs 25 or the base 23. The non-zero angle of incidence of the partial reflections means the partial reflections can be at least partially re-reflected or scattered back towards the exit pupil at a non-zero angle to the optical axis 9. The re-reflected or scattered light may have an intensity profile that peaks at the opposite region of the exit pupil from where the partial reflection originated. The re-reflected or scattered light can be absorbed by a light blocker at this opposite region. Thus, ghost images can be prevented, or at least have their intensity greatly reduced, even when using an emissive display 22.

FIG. 20 illustrates one way of reducing the cone angle of emitted images from an emissive display. It is envisaged that other ways of achieving the same effect using an emissive display 22 would be possible. In one further example, the collimating tubes 27 could be replaced with micro lenses positioned over each LED 25 that shape the emitted light 26 into a narrower cone angle on one side. This can provide a plurality of cones of light, where each cone has a chief ray that is not parallel with the optical axis of the system.

Various embodiments of the light projector 100 and the light projector 200 have been described above with a single reflective display using two light sources to generate two sets of images independently. However, it should also be understood that the light sources and reflective displays of the light projectors 100, 200 could be implemented using multiple emissive displays. For example, embodiments of the emissive display 22 could replace the reflective displays and light sources, in order to provide two or more sets of images to the user while enabling efficient prevention of ghost images.

Embodiments of the light projector 100 and the light projector 200 discussed above have two opposing “image channels” (e.g., two light sources and a reflective display or two separate emissive displays) configured to generate images independently. Each image channel is symmetrically positioned about the optical axis 9 relative to the other, so that ghost images from one channel align with an input region on the exit pupil used by the other, and vice versa. As described above, this alignment enables selective blocking of ghost images from both channels using a switchable light blocker at each input region.

In further embodiments, one or more additional image channels could also be added at spaced positions in the light projector 100 or the light projector 200 about the optical axis 9. For example, if first and second emissive displays are provided as opposing imaging channels that use upper and lower regions of the exit pupil, respectively, third and fourth emissive displays could also be provided that couple images towards left and right regions of the exit pupil, respectively. In this case, each region of the exit pupil may be non-overlapping with the others and each may be positioned off-centre from the optical axis 9 in an equal and opposite direction to its opposing region. Corresponding light blockers may be positioned over each of the upper, left, right and lower regions of the exit pupil.

Equally, multiple imaging channels could also be provided using a reflective or transmissive display and multiple light sources.

It is envisaged that in some embodiments the light projectors 100, 200 could be provided with 3 or more pairs of opposing imaging channels.

In embodiments using multiple image channels, each image channel could be used sequentially to provide different images or the same image to the user. The image channel in use may change each frame. In one example, two channels from different channel pairs may be active at the same time, each respective channel pair being in an anti-ghosting mode to prevent ghost images from either active channel from entering the waveguide. Alternatively, a plurality of imaging channels may be active at the same time in a bright mode, in order to increase the user-perceived brightness in bright ambient lighting conditions.

Two or more imaging channels may be active at the same time to achieve various effects. Any aspect of the light forming the image may be varied between imaging channels. For example, the hue, intensity, saturation, colour, resolution, field of view, frame rate, gamma or any other feature of a display that can be adjusted may be adjusted. Two or more imaging channels may also be used to provide stereoscopic images to the user.

1. A projector for an augmented reality or mixed reality headset, comprising:
a display defining an optical axis, configured to provide first supplied light;
an exit pupil configured to couple the first supplied light into a waveguide for an augmented reality or mixed reality headset, the exit pupil comprising a first region and a second region;
a first optical arrangement configured to couple the first supplied light from the display towards the exit pupil; and
a first light blocker;
wherein the first region is positioned off-centre from the optical axis in a first direction to enable a first partial reflection, formed by a partial reflection of the first supplied light at the exit pupil, to be reflected towards the display and reflected by the display back towards the second region of the exit pupil, which is off-centre from the optical axis in a second direction so that the first and second regions are at least partially spatially separated from one another;
wherein the first light blocker is positioned at the second region to at least partially prevent the first partial reflection from being coupled into the waveguide, while enabling the first supplied light to be coupled into the waveguide through the first region.

2. The projector of claim 1, wherein the display is configured to provide the first supplied light to the first optical arrangement off-centre with respect to the optical axis so that the first supplied light is coupled towards the first region of the exit pupil.

3. The projector of claim 2, further comprising:
a first light source configured to illuminate the display to generate the first supplied light; and
a second optical arrangement configured to couple light from the first light source to the display;
wherein the display is a reflective display and the first light source and/or the second optical arrangement are configured to provide asymmetrical illumination of the display with respect to the optical axis to enable the display to provide the first supplied light to the first optical arrangement off-centre with respect to the optical axis.

4. The projector of claim 3, wherein the first light blocker is switchable between a first state configured to at least partially prevent the first partial reflection from being coupled into the waveguide and a second state configured to enable light to be coupled into the waveguide.

5. The projector of claim 4, comprising a second light source configured to illuminate the display to enable the display to generate second supplied light, wherein the second light source and the second optical arrangement are configured to provide asymmetrical illumination of the display with respect to the optical axis to enable the display to provide the second supplied light to the first optical arrangement at a position that is off-centre with respect to the optical axis so that the second supplied light is coupled towards the second region of the exit pupil.

6. The projector of claim 5, wherein the second region is positioned off-centre with respect to the optical axis to enable a second partial reflection, formed by a partial reflection of the second supplied light at the exit pupil, to be reflected towards the display and reflected by the display back towards the first region of the exit pupil.

7. The projector of claim 5, comprising a second light blocker positioned at the first region, wherein the second light blocker is switchable between a third state configured to at least partially prevent the second supplied light from being coupled into the waveguide and a fourth state configured to enable light to be coupled into the waveguide.

8. The projector of claim 7, wherein the first light source and the second light source are configured to operate simultaneously while the first light blocker is in the second state and the second light blocker is in the fourth state.

9. The projector of claim 7, wherein the light projector is configured to switch between a first configuration in which the first light source is turned on, the second light source is turned off, the first light blocker is in the first state and the second light blocker is in the fourth state, and a second configuration in which the first light source is turned off, the second light source is turned on, the first light blocker is in the second state and the second light blocker is in the third state.

10. The projector of claim 3, wherein the second optical arrangement comprises a micro lens array.

11. The projector of claim 10, wherein the first light source is configured to illuminate the micro lens array preferentially on one side of the micro lens array.

12. The projector of claim 1, wherein the first light blocker comprises a polariser configured to block light of a first polarisation angle, and a switchable waveplate configured to selectively transpose light coupled towards the polariser from a second polarisation angle, the second polarisation angle being perpendicular to the first polarisation angle.

13. The projector of claim 1, wherein the first region and the second region are spatially separated along a longitudinal axis, and wherein the longitudinal axis is oriented to minimise a distance between the display and the exit pupil.

14. The projector of claim 1, comprising a waveguide for an augmented reality or mixed reality headset, configured to receive the supplied light from the exit pupil and couple the supplied light towards a user.

15. A projector for an augmented reality or mixed reality headset, comprising:
a display defining an optical axis, configured to generate first supplied light and second supplied light;
an exit pupil configured to couple the first supplied light and the second supplied light into one or more waveguides for an augmented reality or mixed reality headset, the exit pupil comprising a first region and a second region; and
a first optical arrangement configured to couple the first supplied light and the second supplied light from the display towards the exit pupil;
wherein the display is configured to provide the first supplied light and the second supplied light respectively to the first optical arrangement off-centre with respect to the optical axis so that the first supplied light is coupled towards the first region of the exit pupil and the second supplied light is coupled towards the second region of the exit pupil;
wherein the first region is positioned off-centre from the optical axis in a first direction and the second region is positioned off-centre from the optical axis in a second direction so that the first and second regions are at least partially spatially separated from one another.

16. The projector of claim 15, further comprising:
a first light source configured to illuminate the display to generate the first supplied light; and
a second optical arrangement configured to couple light from the first light source to the display.

17. The projector of claim 16, wherein the second optical arrangement comprises a micro lens array.

18. The projector of claim 17, wherein the first light source is configured to illuminate the micro lens array preferentially on one side of the micro lens array.

19. The projector of claim 16, comprising a second light source configured to illuminate the display to enable the display to generate the second supplied light.

20. The projector of claim 15, wherein the second region is positioned off-centre with respect to the optical axis to enable a second partial reflection, formed by a partial reflection of the second supplied light at the exit pupil, to be reflected towards the display and reflected by the display back towards the first region of the exit pupil.
